(19) United States
(12) Patent Application Publication
(10) Pub. No.: US 2025/0071720 A1
(43) Pub. Date: Feb. 27, 2025

(54) STORAGE OF MULTIPLE POSITIONING CAPABILITY SETS AND ACTIVATION/DEACTIVATION TRIGGERING OPTIONS

(71) Applicant: QUALCOMM Incorporated, San Diego, CA (US)

(72) Inventors: Alexandros MANOLAKOS, Athens (GR); Mukesh KUMAR, Hyderabad (IN); Srinivas YERRAMALLI, San Diego, CA (US)

(21) Appl. No.: 18/727,660

(22) PCT Filed: Jan. 11, 2023
(86) PCT No.: PCT/US2023/010612

§ 371 Date: Jul. 9, 2024

(30) Foreign Application Priority Data
Mar. 8, 2022 (GR) 20220100215

(51) Int. Cl. H04W 64/00; H04W 72/21; H04W 72/25; H04W 72/51

(52) U.S. Cl. CPC H04W 64/00; H04W 72/21; H04W 72/25; H04W 72/51

(57) ABSTRACT

Aspects presented herein may enable a UE to store multiple sets of UE processing capabilities at one or more entities, and to activate one of the stored sets based on the UE's current processing availabilities to improve positioning latency. In one aspect, a UE transmits, to at least one of a second UE, a base station, or a network entity, a plurality of capability sets associated with UE positioning processing, the plurality of capability sets including at least a first capability set corresponding to a first level of the UE positioning processing and a second capability set corresponding to a second level of the UE positioning processing, the first level being different from the second level. The UE transmits, to the at least one of the second UE, the base station, or the network entity, an indication to activate one of the plurality of capability sets for UE positioning.

### CROSS-REFERENCE TO RELATED APPLICATION

This application claims the benefit of Greek Provisional Patent Application Ser. No. 20220100215 entitled “STORAGE OF MULTIPLE POSITIONING CAPABILITY SETS AND ACTIVATION/DEACTIVATION TRIGGERING OPTIONS” and filed on Mar. 8, 2022, which is expressly incorporated by reference herein in its entirety.

### TECHNICAL FIELD

The present disclosure relates generally to communication systems, and more particularly, to wireless communications involving positioning.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

Some communication systems may also support a number of cellular network-based positioning technologies, where the geographic location of a wireless device may be determined based on measuring radio signals exchanged between the wireless device and other wireless devices. For example, a distance between a wireless device and a transmission reception point (TRP) may be estimated based on the time it takes for a reference signal (e.g., a positioning reference signal (PRS)) transmitted from the TRP to reach the wireless device. Other examples of cellular network-based positioning technologies may include downlink-based, uplink-based, and/or downlink-and-uplink-based positioning methods.

### BRIEF SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus transmits, to at least one of a second UE, a base station, or a network entity, a plurality of capability sets associated with UE positioning processing, the plurality of capability sets including at least a first capability set corresponding to a first level of the UE positioning processing and a second capability set corresponding to a second level of the UE positioning processing, the first level being different from the second level. The apparatus transmits, to the at least one of the second UE, the base station, or the network entity, an indication to activate one of the plurality of capability sets for UE positioning.

In an aspect of the disclosure, a method, a computer-readable medium, and an apparatus are provided. The apparatus receives, from a user equipment (UE), a plurality of capability sets associated with UE positioning processing, the plurality of capability sets including at least a first capability set corresponding to a first level of the UE positioning processing and a second capability set corresponding to a second level of the UE positioning processing, the first level being different from the second level. The apparatus receives, from the UE, an indication to activate one of the plurality of capability sets for UE positioning.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of DL channels within a subframe, in accordance with various aspects of the present disclosure.

FIG. 2C is a diagram illustrating an example of a second frame, in accordance with various aspects of the present disclosure.

FIG. 2D is a diagram illustrating an example of UL channels within a subframe, in accordance with various aspects of the present disclosure.

FIG. 3 is a diagram illustrating an example of a base station and user equipment (UE) in an access network.

FIG. 4 is a diagram illustrating an example of a UE positioning based on reference signal measurements in accordance with various aspects of the present disclosure.

FIG. 5A is a diagram illustrating an example of downlink-positioning reference signal (DL-PRS) transmitted from multiple transmission-reception points (TRPs) in accordance with various aspects of the present disclosure.

FIG. 5B is a diagram illustrating an example of uplink-sounding reference signal (UL-SRS) transmitted from a UE in accordance with various aspects of the present disclosure.

FIG. 6 is a diagram illustrating an example of estimating a position of a UE based on multi-round trip time (RTT) measurements from multiple TRPs in accordance with various aspects of the present disclosure.

FIG. 7 is a communication flow illustrating an example multi-RTT positioning procedure in accordance with various aspects of the present disclosure.

FIG. 8 is a communication flow illustrating example main steps of a UE positioning operation in accordance with various aspects of the present disclosure.

FIG. 9 is a communication flow illustrating an example of an access and mobility management function (AMF) storing UE positioning capabilities in accordance with various aspects of the present disclosure.

FIG. 10 is a communication flow illustrating an example capability transfer procedure (e.g., an LTE positioning protocol (LPP) capability transfer procedure) in accordance with various aspects of the present disclosure.

FIG. 11 is a communication flow illustrating an example capability indication procedure (e.g., an LPP capability indication procedure) in accordance with various aspects of the present disclosure.

FIG. 12 is a communication flow illustrating an example of storing UE positioning capabilities at an AMF in accordance with various aspects of the present disclosure.

FIG. 13 is a communication flow illustrating an example of a UE storing multiple sets of UE processing capabilities at a network entity in accordance with various aspects of the present disclosure.

FIG. 14 is a communication flow illustrating an example of a UE storing multiple sets of UE SL processing capabilities at an SL positioning entity in accordance with various aspects of the present disclosure.

FIG. 15 is a flowchart of a method of wireless communication in accordance with aspects presented herein.

FIG. 16 is a flowchart of a method of wireless communication in accordance with aspects presented herein.

FIG. 17 is a diagram illustrating an example of a hardware implementation for an example apparatus in accordance with aspects presented herein.

FIG. 18 is a flowchart of a method of wireless communication in accordance with aspects presented herein.

FIG. 19 is a flowchart of a method of wireless communication in accordance with aspects presented herein.

FIG. 20 is a diagram illustrating an example of a hardware implementation for an example apparatus in accordance with aspects presented herein.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects and implementations are described in this application by illustration to some examples, those skilled in the art will understand that additional implementations and use cases may come about in many different arrangements and scenarios. Innovations described herein may be implemented across many differing platform types, devices, systems, shapes, sizes, and packaging arrangements. For example, implementations and/or uses may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described innovations may occur. Implementations may range a spectrum from chip-level or modular components to non-modular, non-chip-level implementations and further to aggregate, distributed, or original equipment manufacturer (OEM) devices or systems incorporating one or more aspects of the described innovations. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). It is intended that innovations described herein may be practiced in a wide variety of devices, chip-level components, systems, distributed arrangements, aggregated or disaggregated components, end-user devices, etc. of varying sizes, shapes, and constitution.

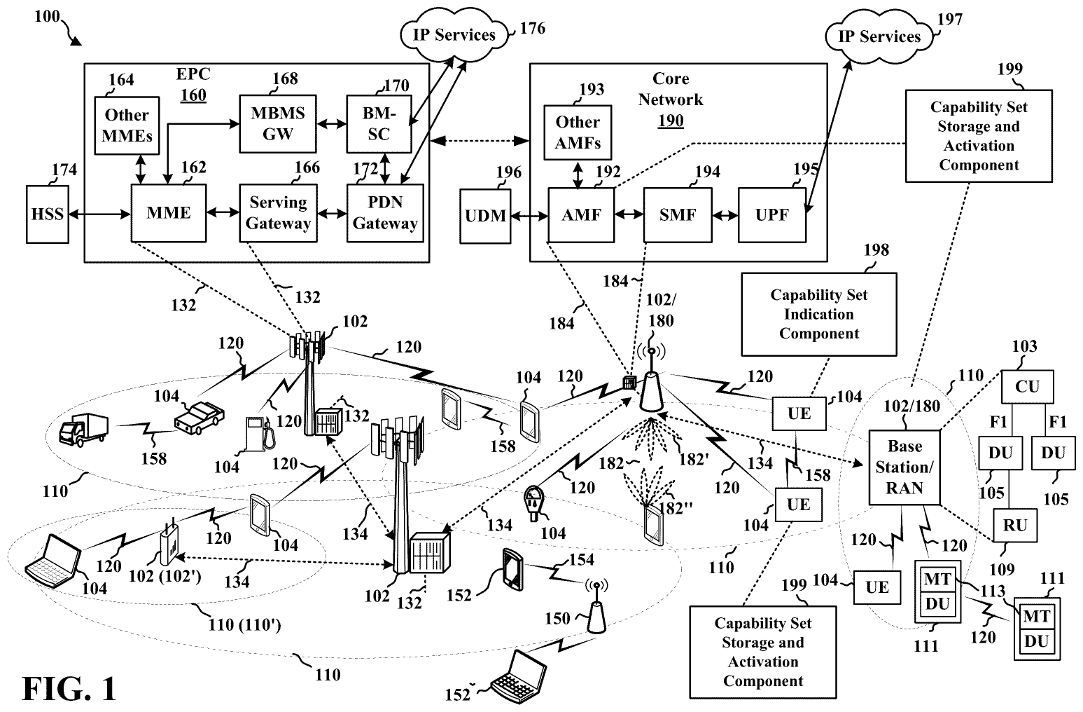

FIG. 1 is a diagram illustrating an example of a wireless communications system and an access network 100. The wireless communications system (also referred to as a wireless wide area network (WWAN)) includes base stations 102, UEs 104, an Evolved Packet Core (EPC) 160, and another core network 190 (e.g., a 5G Core (5GC)). The base stations 102 may include macrocells (high power cellular base station) and/or small cells (low power cellular base station). The macrocells include base stations. The small cells include femtocells, picocells, and microcells.

Aspects presented herein may improve the performance and latency of UE positioning. Aspects presented herein may enable a UE to store multiple sets of UE processing capabilities at one or more network entities, such as at an AMF, an LMF, and/or another UE. Each of the multiple sets of UE processing capabilities may include a different level of UE positioning processing. As such, the UE may indicate to the one or more network entities which set of the UE processing capabilities to activate based on the UE's current processing availabilities/capabilities to improve positioning efficiency and latency.

In certain aspects, the UE 104 may include a capability set indication component 198 configured to store multiple sets of UE processing capabilities at one or more network entities, and to activate one set of the stored UE processing capabilities based on the UE's current processing availabilities. In one configuration, the capability set indication component 198 may be configured to transmit, to at least one of a second UE, a base station, or a network entity, a plurality of capability sets associated with UE positioning processing, the plurality of capability sets including at least a first capability set corresponding to a first level of the UE positioning processing and a second capability set corresponding to a second level of the UE positioning processing, the first level being different from the second level. In such configuration, the capability set indication component 198 may transmit, to the at least one of the second UE, the base station, or the network entity, an indication to activate one of the plurality of capability sets for UE positioning.

In certain aspects, the UE 104, the base station 102/180, the AMF 192, an LMF, and/or a GMLC may include a capability set storage and activation component 199 configured to store multiple sets of UE processing capabilities for a UE, and to activate one set of the stored UE processing capabilities for the UE based on the UE's indication. In one configuration, the capability set storage and activation component 199 may be configured to receive, from a UE, a plurality of capability sets associated with UE positioning processing, the plurality of capability sets including at least a first capability set corresponding to a first level of the UE positioning processing and a second capability set corresponding to a second level of the UE positioning processing, the first level being different from the second level. In such configuration, the capability set storage and activation component 199 may receive, from the UE, an indication to activate one of the plurality of capability sets for UE positioning.

The base stations 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., S1 interface). The base stations 102 configured for 5G NR (collectively referred to as Next Generation RAN (NG-RAN)) may interface with core network 190 through second backhaul links 184. In addition to other functions, the base stations 102 may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The base stations 102 may communicate directly or indirectly (e.g., through the EPC 160 or core network 190) with each other over third backhaul links 134 (e.g., X2 interface). The first backhaul links 132, the second backhaul links 184, and the third backhaul links 134 may be wired or wireless.

In some aspects, a base station 102 or 180 may be referred as a RAN and may include aggregated or disaggregated components. As an example of a disaggregated RAN, a base station may include a central unit (CU) 103, one or more distributed units (DU) 105, and/or one or more remote units (RU) 109, as illustrated in FIG. 1. A RAN may be disaggregated with a split between an RU 109 and an aggregated CU/DU. A RAN may be disaggregated with a split between the CU 103, the DU 105, and the RU 109. A RAN may be disaggregated with a split between the CU 103 and an aggregated DU/RU. The CU 103 and the one or more DUs 105 may be connected via an F1 interface. A DU 105 and an RU 109 may be connected via a fronthaul interface. A connection between the CU 103 and a DU 105 may be referred to as a midhaul, and a connection between a DU 105 and an RU 109 may be referred to as a fronthaul. The connection between the CU 103 and the core network may be referred to as the backhaul. The RAN may be based on a functional split between various components of the RAN, e.g., between the CU 103, the DU 105, or the RU 109. The CU may be configured to perform one or more aspects of a wireless communication protocol, e.g., handling one or more layers of a protocol stack, and the DU(s) may be configured to handle other aspects of the wireless communication protocol, e.g., other layers of the protocol stack. In different implementations, the split between the layers handled by the CU and the layers handled by the DU may occur at different layers of a protocol stack. As one, non-limiting example, a DU 105 may provide a logical node to host a radio link control (RLC) layer, a medium access control (MAC) layer, and at least a portion of a physical (PHY) layer based on the functional split. An RU may provide a logical node configured to host at least a portion of the PHY layer and radio frequency (RF) processing. A CU 103 may host higher layer functions, e.g., above the RLC layer, such as a service data adaptation protocol (SDAP) layer, a packet data convergence protocol (PDCP) layer. In other implementations, the split between the layer functions provided by the CU, DU, or RU may be different.

An access network may include one or more integrated access and backhaul (IAB) nodes 111 that exchange wireless communication with a UE 104 or other IAB node 111 to provide access and backhaul to a core network. In an IAB network of multiple IAB nodes, an anchor node may be referred to as an IAB donor. The IAB donor may be a base station 102 or 180 that provides access to a core network 190 or EPC 160 and/or control to one or more IAB nodes 111. The IAB donor may include a CU 103 and a DU 105. IAB nodes 111 may include a DU 105 and a mobile termination (MT) 113. The DU 105 of an IAB node 111 may operate as a parent node, and the MT 113 may operate as a child node.

The base stations 102 may wirelessly communicate with the UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, WiMedia, Bluetooth, ZigBee, Wi-Fi based on the Institute of Electrical and Electronics Engineers (IEEE) 802.11 standard, LTE, or NR.

The wireless communications system may further include a Wi-Fi access point (AP) 150 in communication with Wi-Fi stations (STAs) 152 via communication links 154, e.g., in a 5 GHz unlicensed frequency spectrum or the like. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same unlicensed frequency spectrum (e.g., 5 GHz, or the like) as used by the Wi-Fi AP 150. The small cell 102′, employing NR in an unlicensed frequency spectrum, may boost coverage to and/or increase capacity of the access network.

The electromagnetic spectrum is often subdivided, based on frequency/wavelength, into various classes, bands, channels, etc. In 5G NR, two initial operating bands have been identified as frequency range designations FR1 (410 MHz-7.125 GHz) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHz), FR4 (52.6 GHz-114.25 GHz), and FR5 (114.25 GHz-300 GHz). Each of these higher frequency bands falls within the EHF band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “millimeter wave” or the like if used herein may broadly represent frequencies that may include mid-band frequencies, may be within FR2, FR4, FR2-2, and/or FR5, or may be within the EHF band.

A base station 102, whether a small cell 102′ or a large cell (e.g., macro base station), may include and/or be referred to as an eNB, gNodeB (gNB), or another type of base station. Some base stations, such as gNB 180 may operate in a traditional sub 6 GHz spectrum, in millimeter wave frequencies, and/or near millimeter wave frequencies in communication with the UE 104. When the gNB 180 operates in millimeter wave or near millimeter wave frequencies, the gNB 180 may be referred to as a millimeter wave base station. The millimeter wave base station 180 may utilize beamforming 182 with the UE 104 to compensate for the path loss and short range. The base station 180 and the UE 104 may each include a plurality of antennas, such as antenna elements, antenna panels, and/or antenna arrays to facilitate the beamforming.

The base station 180 may transmit a beamformed signal to the UE 104 in one or more transmit directions 182′. The UE 104 may receive the beamformed signal from the base station 180 in one or more receive directions 182″. The UE 104 may also transmit a beamformed signal to the base station 180 in one or more transmit directions. The base station 180 may receive the beamformed signal from the UE 104 in one or more receive directions. The base station 180/UE 104 may perform beam training to determine the best receive and transmit directions for each of the base station 180/UE 104. The transmit and receive directions for the base station 180 may or may not be the same. The transmit and receive directions for the UE 104 may or may not be the same.

The EPC 160 may include a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The core network 190 may include an Access and Mobility Management Function (AMF) 192, other AMFs 193, a Session Management Function (SMF) 194, and a User Plane Function (UPF) 195. The AMF 192 may be in communication with a Unified Data Management (UDM) 196. The AMF 192 is the control node that processes the signaling between the UEs 104 and the core network 190. Generally, the AMF 192 provides QoS flow and session management. All user Internet protocol (IP) packets are transferred through the UPF 195. The UPF 195 provides UE IP address allocation as well as other functions. The UPF 195 is connected to the IP Services 197. The IP Services 197 may include the Internet, an intranet, an IP Multimedia Subsystem (IMS), a Packet Switch (PS) Streaming (PSS) Service, and/or other IP services.

The base station may include and/or be referred to as a gNB, Node B, eNB, an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or core network 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

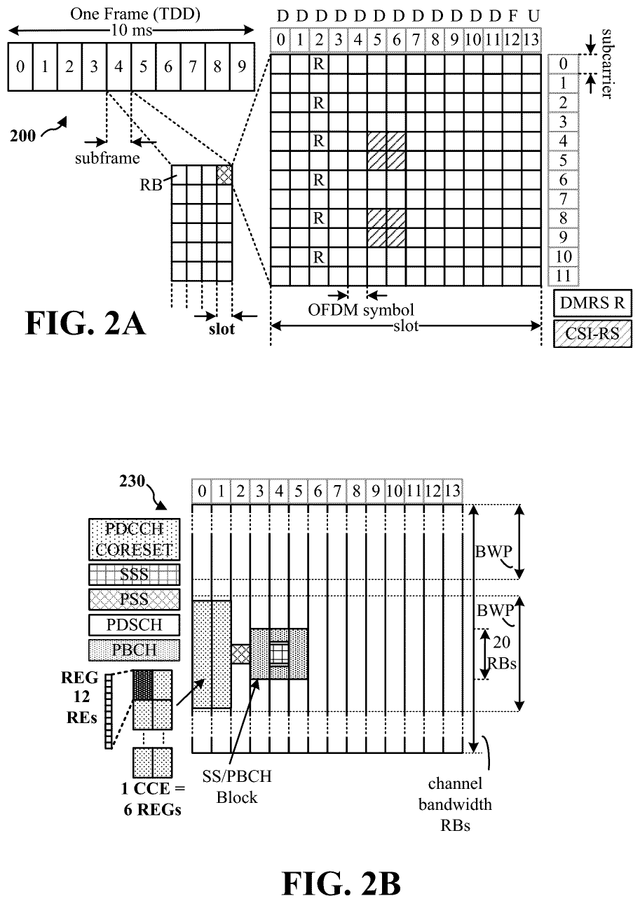

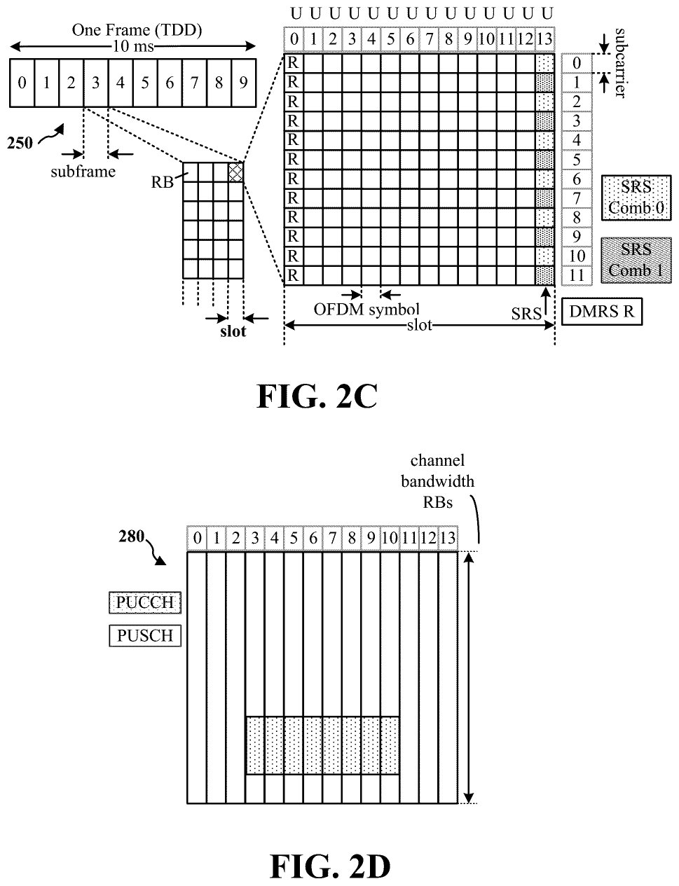

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the CP and the numerology. The numerology defines the subcarrier spacing (SCS) and, effectively, the symbol length/duration, which is equal to 1/SCS.

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, Extended |
| 3 | 120 | Normal |
| 4 | 240 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 2^{μ} slots/subframe. The subcarrier spacing may be equal to 2^{μ}* 15 kHz, where μ is the numerology 0 to 4. As such, the numerology μ=0 has a subcarrier spacing of 15 kHz and the numerology μ=4 has a subcarrier spacing of 240kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

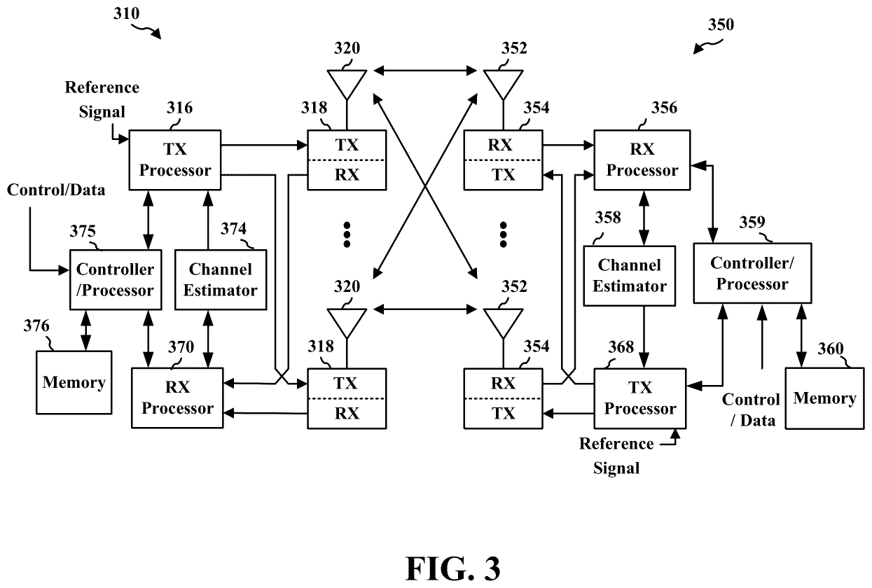

FIG. 3 is a block diagram of a base station 310 in communication with a UE 350 in an access network. In the DL, IP packets from the EPC 160 may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318 TX. Each transmitter 318 TX may modulate a radio frequency (RF) carrier with a respective spatial stream for transmission.

At the UE 350, each receiver 354 RX receives a signal through its respective antenna 352. Each receiver 354 RX recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets from the EPC 160. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354TX. Each transmitter 354TX may modulate an RF carrier with a respective spatial stream for transmission.

The UL transmission is processed at the base station 310 in a manner similar to that described in connection with the receiver function at the UE 350. Each receiver 318RX receives a signal through its respective antenna 320. Each receiver 318RX recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets from the UE 350. IP packets from the controller/processor 375 may be provided to the EPC 160. The controller/processor 375 is also responsible for error detection using an ACK and/or NACK protocol to support HARQ operations.

In some examples, at least one of the TX processor 368, the RX processor 356, and the controller/processor 359 may be configured to perform aspects in connection with the capability set indication component 198 and/or the capability set storage and activation component 199 of FIG. 1. In other examples, at least one of the TX processor 316, the RX processor 370, and the controller/processor 375 may be configured to perform aspects in connection with the capability set storage and activation component 199 of FIG. 1.

A network may support a number of cellular network-based positioning technologies, such as downlink-based, uplink-based, and/or downlink-and-uplink-based positioning methods. Downlink-based positioning methods may include an observed time difference of arrival (OTDOA) (e.g., in LTE), a downlink time difference of arrival (DL-TDOA) (e.g., in NR), and/or a downlink angle-of-departure (DL-AoD) (e.g., in NR). In an OTDOA or DL-TDOA positioning procedure, a UE may measure the differences between each time of arrival (ToA) of reference signals (e.g., positioning reference signals (PRSs)) received from pairs of base stations, referred to as reference signal time difference (RSTD) measurements or time difference of arrival (TDOA) measurements, and report them to a positioning entity (e.g., a location management function (LMF)). For example, the UE may receive identifiers (IDs) of a reference base station (which may also be referred to as a reference cell or a reference gNB) and at least one non-reference base station in assistance data (AD). The UE may then measure the RSTD between the reference base station and each of the non-reference base stations. Based on the known locations of the involved base stations and the RSTD measurements, the positioning entity may estimate a location of the UE. In other words, a position of the UE may be estimated based on measuring reference signals transmitted between the UE and one or more base stations and/or transmission-reception points (TRPs) of the one or more base stations. As such, the PRSs may enable UEs to detect and measure neighbor TRPs, and to perform positioning based on the measurement. For purposes of the present disclosure, the suffixes “-based” and “-assisted” may refer respectively to the node that is responsible for making the positioning calculation (and which may also provide measurements) and a node that provides measurements (but which may not make the positioning calculation). For example, an operation in which measurements are provided by a UE to a base station/positioning entity to be used in the computation of a position estimate may be described as “UE-assisted,” “UE-assisted positioning,” and/or “UE-assisted position calculation” while an operation in which a UE computes its own position may be described as “UE-based,” “UE-based positioning,” and/or “UE-based position calculation.”

In some examples, the term “TRP” may refer to one or more antennas of a base station whereas the term “base station” may refer to a complete unit (e.g., the base station 102/180) that includes aggregated or disaggregated components, such as described in connection with FIG. 1. For example, as an example of a disaggregated RAN, a base station may include CU, one or more DUs, one or more RUs, and/or one or more TRPs. One or more disaggregated components may be located at different locations. For example, different TRPs may be located at different geographic locations. In another example, a TRP may refer to a set of geographically co-located antennas (e.g., antenna array (with one or more antenna elements)) supporting transmission point (TP) and/or reception point (RP) functionality. Thus, a base station may transmit signal to and/or receive signal from other wireless device (e.g., a UE, another base station, etc.) via one or more TRPs. For purposes of the present disclosure, in some examples, the term “TRP” may be used interchangeably with the term “base station.”

For DL-AoD positioning, the positioning entity may use a beam report from the UE of received signal strength measurements of multiple downlink transmit beams to determine the angle(s) between the UE and the transmitting base station(s). The positioning entity may then estimate the location of the UE based on the determined angle(s) and the known location(s) of the transmitting base station(s).

Uplink-based positioning methods may include UL-TDOA and UL-AoA. UL-TDOA is similar to DL-TDOA, but is based on uplink reference signals (e.g., sounding reference signals (SRSs)) transmitted by the UE. For UL-AoA positioning, one or more base stations may measure the received signal strength of one or more uplink reference signals (e.g., SRSs) received from a UE on one or more uplink receive beams. The positioning entity may use the signal strength measurements and the angle(s) of the receive beam(s) to determine the angle(s) between the UE and the base station(s). Based on the determined angle(s) and the known location(s) of the base station(s), the positioning entity can then estimate the location of the UE.

Downlink-and-uplink-based positioning methods may include enhanced cell-ID (E-CID) positioning and multi-round-trip-time (RTT) positioning (also referred to as “multi-cell RTT”). In an RTT procedure, an initiator (a base station or a UE) transmits an RTT measurement signal (e.g., a PRS or SRS) to a responder (a UE or a base station), which transmits an RTT response signal (e.g., an SRS or a PRS) back to the initiator. The RTT response signal may include the difference between the ToA of the RTT measurement signal and the transmission time of the RTT response signal, referred to as the reception-to-transmission (Rx-Tx) time difference. The initiator may calculate the difference between the transmission time of the RTT measurement signal and the ToA of the RTT response signal, referred to as the transmission-to-reception (Tx-Rx) time difference. The propagation time (also referred to as the “time of flight”) between the initiator and the responder may be calculated from the Tx-Rx and Rx-Tx time differences. Based on the propagation time and the known speed of light, the distance between the initiator and the responder may be determined. For multi-RTT positioning, a UE may perform an RTT procedure with multiple base stations to enable its location to be determined (e.g., using multilateration) based on the known locations of the base stations. RTT and multi-RTT methods may be combined with other positioning techniques, such as UL-AoA and DL-AoD, to improve location accuracy.

The E-CID positioning method may be based on radio resource management (RRM) measurements. In E-CID, the UE may report the serving cell ID and the timing advance (TA), as well as the identifiers, estimated timing, and signal strength of detected neighbor base stations. The location of the UE is then estimated based on this information and the known locations of the base station(s).

To assist positioning operations, a location server (e.g., a location server, an LMF, or an SLP) may provide assistance data (AD) to the UE. For example, the assistance data may include identifiers of the base stations (or the cells/TRPs of the base stations) from which to measure reference signals, the reference signal configuration parameters (e.g., the number of consecutive positioning subframes, periodicity of positioning subframes, muting sequence, frequency hopping sequence, reference signal identifier, reference signal bandwidth, etc.), and/or other parameters applicable to the particular positioning method. Alternatively, the assistance data may originate directly from the base stations (e.g., in periodically broadcasted overhead messages, etc.). In some cases, the UE may be able to detect neighbor network nodes without the use of assistance data.

In the case of an OTDOA or DL-TDOA positioning procedure, the assistance data may further include an expected RSTD value and an associated uncertainty (e.g., a search space window) around the expected RSTD. In some cases, the value range of the expected RSTD may be plus-minus (+/−) 500 microseconds (μs). In some cases, when any of the resources used for the positioning measurement are in FR1, the value range for the uncertainty of the expected RSTD may be +/−32 μs. In other cases, when all of the resources used for the positioning measurement(s) are in FR2, the value range for the uncertainty of the expected RSTD may be +/−8 μs. In this context, “RSTD” may refer to one or more measurements indicative of a difference in time of arrival between a PRS transmitted by a base station, referred to herein as a “neighbor base station” or a “measuring base station,” and a PRS transmitted by a reference base station. A reference base station may be selected by a location server and/or by a UE to provide good or sufficient signal strength observed at a UE, such that a PRS may be more accurately and/or more quickly acquired and/or measured, such as without any special assistance from a serving base station.

A location estimate may also be referred to as a position estimate, location, position, position fix, fix, or the like. A location estimate may be geodetic and include coordinates (e.g., latitude, longitude, and possibly altitude) or may be civic and include a street address, postal address, or some other verbal description of a location. A location estimate may further be defined relative to some other known location or defined in absolute terms (e.g., using latitude, longitude, and possibly altitude). A location estimate may include an expected error or uncertainty (e.g., by including an area or volume within which the location is expected to be included with some specified or default level of confidence). For purposes of the present disclosure, reference signals may include PRS, tracking reference signals (TRS), phase tracking reference signals (PTRS), cell-specific reference signals (CRS), CSI-RS, demodulation reference signals (DMRS), PSS, SSS, SSBs, SRS, etc., depending on whether the illustrated frame structure is used for uplink or downlink communication. In some examples, a collection of resource elements (REs) that are used for transmission of PRS may be referred to as a “PRS resource.” The collection of resource elements may span multiple PRBs in the frequency domain and one or more consecutive symbol(s) within a slot in the time domain. In a given OFDM symbol in the time domain, a PRS resource may occupy consecutive PRBs in the frequency domain. In other examples, a “PRS resource set” may refer to a set of PRS resources used for the transmission of PRS signals, where each PRS resource may have a PRS resource ID. In addition, the PRS resources in a PRS resource set may be associated with a same TRP. A PRS resource set may be identified by a PRS resource set ID and may be associated with a particular TRP (e.g., identified by a TRP ID). In addition, the PRS resources in a PRS resource set may have a same periodicity, a common muting pattern configuration, and/or a same repetition factor across slots. The periodicity may be a time from a first repetition of a first PRS resource of a first PRS instance to the same first repetition of the same first PRS resource of the next PRS instance. For example, the periodicity may have a length selected from 2\hat{ }μ*{4, 5, 8, 10, 16, 20, 32, 40, 64, 80, 160, 320, 640, 1280, 2560, 5120, 10240} slots, where μ=0, 1, 2, 3. The repetition factor may have a length selected from {1, 2, 4, 6, 8, 16, 32} slots. A PRS resource ID in a PRS resource set may be associated with a single beam (or beam ID) transmitted from a single TRP (where a TRP may transmit one or more beams). That is, each PRS resource of a PRS resource set may be transmitted on a different beam, and as such, a “PRS resource,” or simply “resource,” also can be referred to as a “beam.” In some examples, a “PRS instance” or “PRS occasion” may be one instance of a periodically repeated time window (such as a group of one or more consecutive slots) where PRS are expected to be transmitted. A PRS occasion also may be referred to as a “PRS positioning occasion,” a “PRS positioning instance,” a “positioning occasion,” “a positioning instance,” a “positioning repetition,” or simply an “occasion,” an “instance,” and/or a “repetition,” etc.

A positioning frequency layer (PFL) (which may also be referred to as a “frequency layer”) may be a collection of one or more PRS resource sets across one or more TRPs that have the same values for certain parameters. Specifically, the collection of PRS resource sets may have a same subcarrier spacing and cyclic prefix (CP) type (e.g., meaning all numerologies supported for PDSCHs are also supported for PRS), the same Point A, the same value of the downlink PRS bandwidth, the same start PRB (and center frequency), and/or the same comb-size, etc. The Point A parameter may take the value of a parameter ARFCN-ValueNR (where “ARFCN” stands for “absolute radio-frequency channel number”) and may be an identifier/code that specifies a pair of physical radio channel used for transmission and reception. In some examples, a downlink PRS bandwidth may have a granularity of four PRBs, with a minimum of 24 PRBs and a maximum of 272 PRBs. In other examples, up to four frequency layers may be configured, and up to two PRS resource sets may be configured per TRP per frequency layer.

The concept of a frequency layer may be similar to a component carrier (CC) and a BWP, where CCs and BWPs may be used by one base station (or a macro cell base station and a small cell base station) to transmit data channels, while frequency layers may be used by multiple (e.g., three or more) base stations to transmit PRS. A UE may indicate the number of frequency layers it is capable of supporting when the UE sends the network its positioning capabilities, such as during a positioning protocol session. For example, a UE may indicate whether it is capable of supporting one or four PFLs.

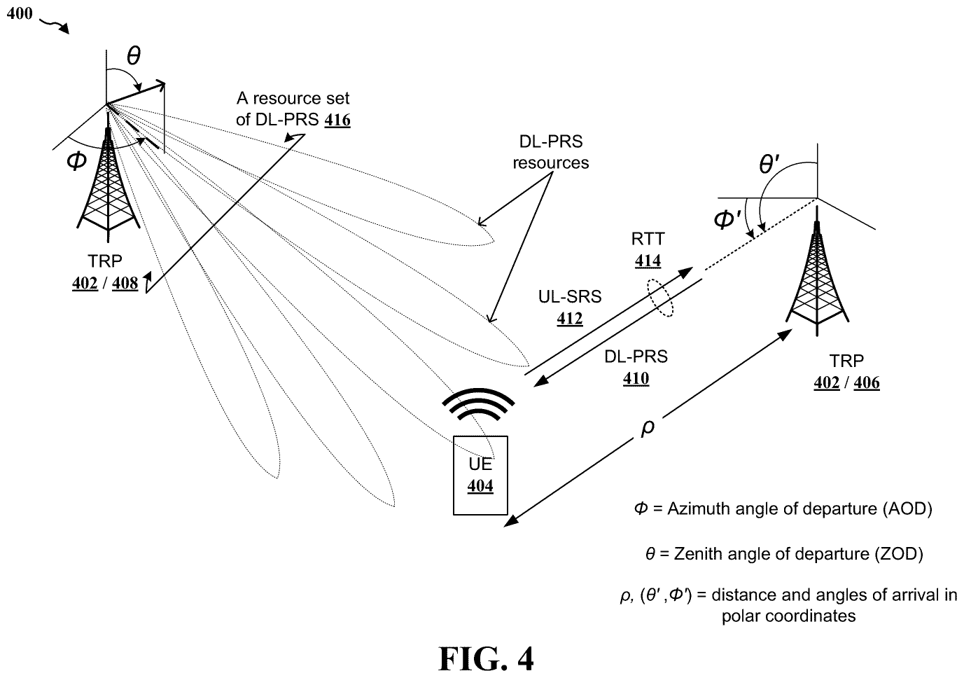

FIG. 4 is a diagram 400 illustrating an example of a UE positioning based on reference signal measurements in accordance with various aspects of the present disclosure. In one example, a location of UE 404 may be estimated based on multi-cell round trip time (multi-RTT) measurements, where multiple TRPs 402 may perform round trip time (RTT) measurements for signals transmitted to and received from the UE 404 to determine the approximate distance of UE 404 with respect to each of the multiple TRPs 402. Similarly, the UE 404 may perform RTT measurements for signals transmitted to and received from the TRPs 402 to determine the approximate distance of each TRP with respect to the UE 404. Then, based at least in part on the approximate distances of UE 404 with respect to the multiple TRPs 402, a location management function (LMF) that is associated with the TRPs 402 and/or the UE 404 may estimate the position of UE 404. For example, a TRP 406 may transmit at least one downlink positioning reference signal (DL-PRS) 410 to the UE 404, and may receive at least one uplink sounding reference signal (UL-SRS) 412 transmitted from the UE 404. Based at least in part on measuring an RTT 414 between the DL-PRS 410 transmitted and the UL-SRS 412 received, a serving base station associated with the TRP 406 or an LMF associated with the TRP 406 may identify the position of UE 404 (e.g., distance) with respect to the TRP 406. Similarly, the UE 404 may transmit UL-SRS 412 to the TRP 406, and may receive DL-PRS 410 transmitted from the TRP 406. Based at least in part on measuring the RTT 414 between the UL-SRS 412 transmitted and the DL-PRS 410 received, the UE 404 or an LMF associated with the UE 404 may identify the position of TRP 406 with respect to the UE 404. The multi-RTT measurement mechanism may be initiated by the LMF that is associated with the TRP 406/408 and/or the UE 404. A TRP may configure UL-SRS resources to a UE via radio resource control (RRC) signaling. In some examples, the UE and the TRP may report the multi-RTT measurements to the LMF, and the LMF may estimate the position of the UE based on the reported multi-RTT measurements.

In other examples, a position of a UE may be estimated based on multiple antenna beam measurements, where a downlink angle of departure (DL-AoD) and/or uplink angle of arrival (UL-AoA) of transmissions between a UE and one or more TRPs may be used to estimate the position of the UE and/or the distance of the UE with respect to each TRP. For example, referring back to FIG. 4, with regard to the DL-AoD, the UE 404 may perform reference signal received power (RSRP) measurements for a set of DL-PRS 416 transmitted from multiple transmitting beams (e.g., DL-PRS beams) of a TRP 408, and the UE 404 may provide the DL-PRS beam measurements to a serving base station (or to the LMF associated with the base station). Based on the DL-PRS beam measurements, the serving TRP or the LMF may derive the azimuth angle (e.g., Φ) of departure and the zenith angle (e.g., θ) of departure for DL-PRS beams of the TRP 408. Then, the serving TRP or the LMF may estimate the position of UE 404 with respect to the TRP 408 based on the azimuth angle of departure and the zenith angle of departure of the DL-PRS beams. Similarly, for the UL-AoA, a position of a UE may be estimated based on UL-SRS beam measurements measured at different TRPs, such as at the TRPs 402. Based on the UL-SRS beam measurements, a serving base station or an LMF associated with the serving base station may derive the azimuth angle of arrival and the zenith angle of arrival for UL-SRS beams from the UE, and the serving base station or the LMF may estimate the position of the UE and/or the UE distance with respect to each of the TRPs based on the azimuth angle of arrival and the zenith angle of arrival of the UL-SRS beams.

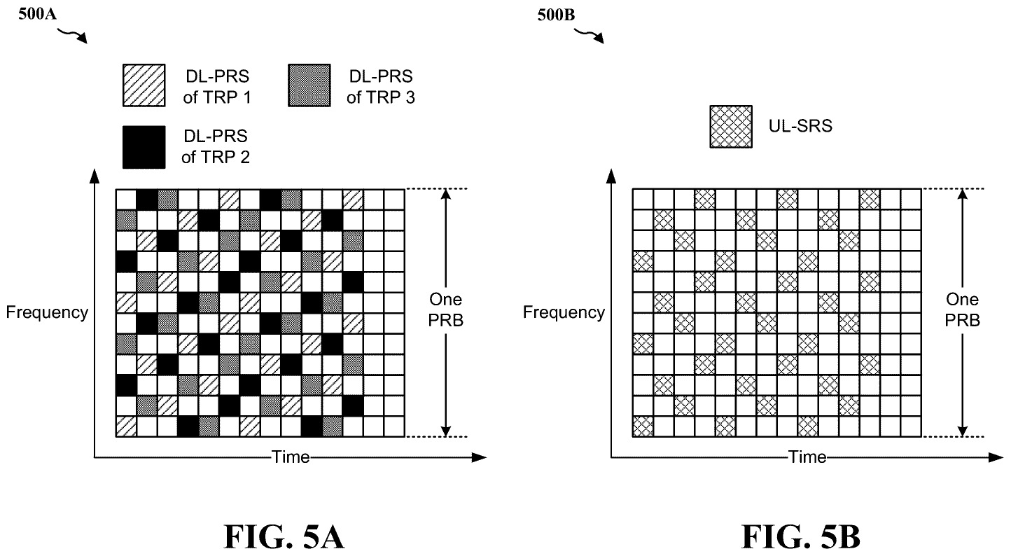

FIG. 5A is a diagram 500A illustrating an example of DL-PRS transmitted from multiple TRPs in accordance with various aspects of the present disclosure. In one example, a serving base station may configure DL-PRS to be transmitted from one or more TRPs within a slot or across multiple slots. If the DL-PRS is configured to be transmitted within a slot, the serving base station may configure the starting resource element in time and frequency from each of the one or more TRPs. If the DL-PRS is configured to be transmitted across multiple slots, the serving base station may configure gaps between DL-PRS slots, periodicity of the DL-PRS, and/or density of the DL-PRS within a period. The serving base station may also configure the DL-PRS to start at any physical resource block (PRB) in the system bandwidth. In one example, the system bandwidth may range from 24 to 276 PRBs in steps of 4 PRBs (e.g., 24, 28, 32, 36, etc.). The serving base station may transmit the DL-PRS in PRS beams, where a PRS beam may be referred to as a “PRS resource” and a full set of PRS beams transmitted from a TRP on a same frequency may be referred to as a “PRS resource set” or a “resource set of PRS,” such as described in connection with FIG. 4. As shown by FIG. 5A, the DL-PRS transmitted from different TRPs and/or from different PRS beams may be multiplexed across symbols or slots.

In some examples, each symbol of the DL-PRS may be configured with a comb-structure in frequency, where the DL-PRS from a TRP of a base station may occupy every Nth subcarrier. The comb value N may be configured to be 2, 4, 6, or 12. The length of the PRS within one slot may be a multiple of N symbols and the position of the first symbol within a slot may be flexible as long as the slot consists of at least N PRS symbols. The diagram 500A shows an example of a comb-6 DL-PRS configuration, where the pattern for the DL-PRS from different TRPs may be repeated after six (6) symbols.

FIG. 5B is a diagram 500B illustrating an example of UL-SRS transmitted from a UE in accordance with various aspects of the present disclosure. In one example, the UL-SRS from a UE may be configured with a comb-4 pattern, where the pattern for UL-SRS may be repeated after four (4) symbols. Similarly, the UL-SRS may be configured in an SRS resource of an SRS resource set, where each SRS resource may correspond to an SRS beam, and the SRS resource sets may correspond to a collection of SRS resources (e.g., beams) configured for a TRP. In some examples, the SRS resources may span 1, 2, 4, 8, or 12 consecutive OFDM symbols. In other examples, the comb size for the UL-SRS may be configured to be 2, 4, or 8.

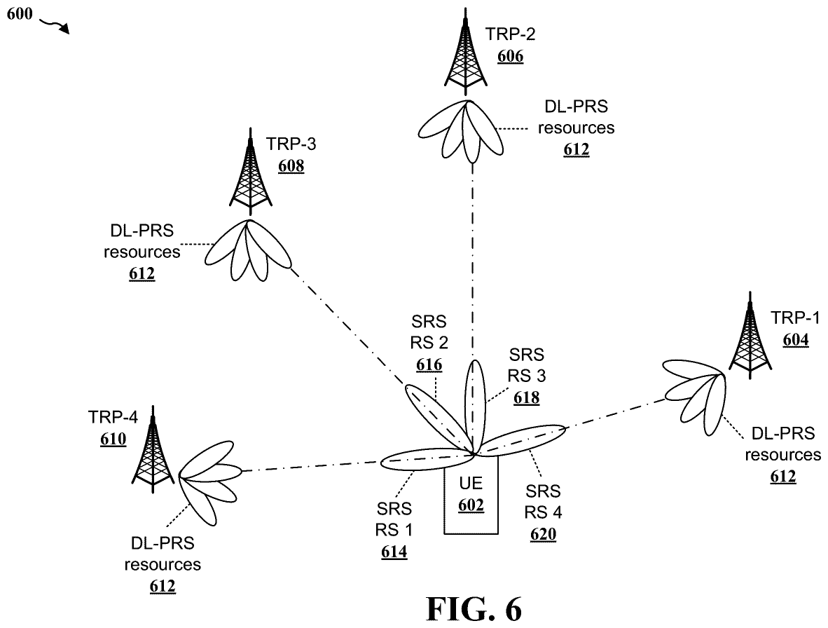

FIG. 6 is a diagram 600 illustrating an example of estimating a position of a UE based on multi-RTT measurements from multiple TRPs in accordance with various aspects of the present disclosure. A UE 602 may be configured by a serving base station to decode DL-PRS resources 612 that correspond to and are transmitted from a first TRP 604 (TRP-1), a second TRP 606 (TRP-2), a third TRP 608 (TRP-3), and a fourth TRP 610 (TRP-4). The UE 602 may also be configured to transmit UL-SRSs on a set of UL-SRS resources, which may include a first SRS resource 614, a second SRS resource 616, a third SRS resource 618, and a fourth SRS resource 620, such that the serving cell(s), e.g., the first TRP 604, the second TRP 606, the third TRP 608, and the fourth TRP 610, and as well as other neighbor cell(s), may be able to measure the set of the UL-SRS resources transmitted from the UE 602. For multi-RTT measurements based on DL-PRS and UL-SRS, as there may be an association between a measurement of a UE for the DL-PRS and a measurement of a TRP for the UL-SRS, the smaller the gap is between the DL-PRS measurement of the UE and the UL-SRS transmission of the UE, the better the accuracy may be for estimating the position of the UE and/or the distance of the UE with respect to each TRP.

Note that the terms “positioning reference signal” and “PRS” generally refer to specific reference signals that are used for positioning in NR and LTE systems. However, as used herein, the terms “positioning reference signal” and “PRS” may also refer to any type of reference signal that can be used for positioning, such as but not limited to, PRS as defined in LTE and NR, TRS, PTRS, CRS, CSI-RS, DMRS, PSS, SSS, SSB, SRS, UL-PRS, etc. In addition, the terms “positioning reference signal” and “PRS” may refer to downlink or uplink positioning reference signals, unless otherwise indicated by the context. If needed to further distinguish the type of PRS, a downlink positioning reference signal may be referred to as a “DL-PRS,” and an uplink positioning reference signal (e.g., an SRS-for-positioning, PTRS) may be referred to as an “UL-PRS.” In addition, for signals that may be transmitted in both the uplink and downlink (e.g., DMRS, PTRS), the signals may be prepended with “UL” or “DL” to distinguish the direction. For example, “UL-DMRS” may be differentiated from “DL-DMRS.”

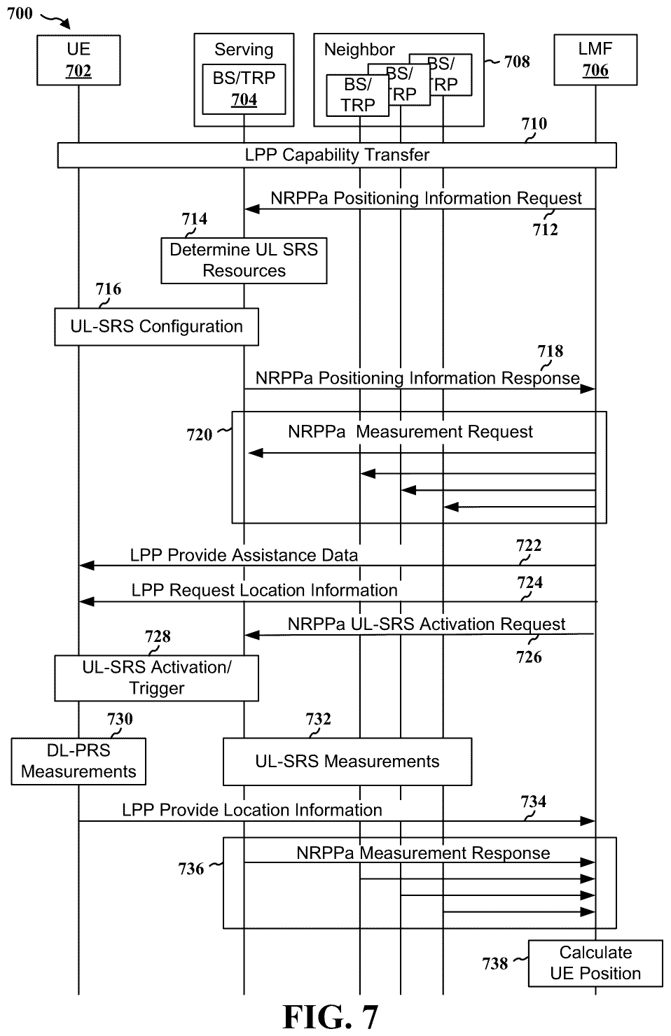

FIG. 7 is a communication flow 700 illustrating an example multi-RTT positioning procedure in accordance with various aspects of the present disclosure. The numberings associated with the communication flow 700 do not specify a particular temporal order and are merely used as references for the communication flow 700. In addition, a DL-only and/or an UL-only positioning may use a subset or subsets of this multi-RTT positioning procedure.

At 710, an LMF 706 may request one or more positioning capabilities from a UE 702 (e.g., from a target device). In some examples, the request for the one or more positioning capabilities from the UE 702 may be associated with an LTE Positioning Protocol (LPP). For example, the LMF 706 may request the positioning capabilities of the UE 702 using an LPP capability transfer procedure.

At 712, the LMF 706 may request UL SRS configuration information for the UE 702. The LMF 706 may also provide assistance data specified by a serving base station 704 (e.g., pathloss reference, spatial relation, and/or SSB configuration(s), etc.). For example, the LMF 706 may send an NR Positioning Protocol A (NRPPa) positioning information request message to the serving base station 704 to request UL information for the UE 702.

At 714, the serving base station 704 may determine resources available for UL SRS, and at 716, the serving base station 704 may configure the UE 702 with one or more UL SRS resource sets based on the available resources.

At 718, the serving base station 704 may provide UL SRS configuration information to the LMF 706, such as via an NRPPa positioning information response message.

At 720, the LMF 706 may select one or more candidate neighbor BSs/TRPs 708, and the LMF 706 may provide an UL SRS configuration to the one or more candidate neighbor BSs/TRPs 708 and/or the serving base station 704, such as via an NRPPa measurement request message. The message may include information for enabling the one or more candidate neighbor BSs/TRPs 708 and/or the serving base station to perform the UL measurements.

At 722, the LMF 706 may send an LPP provide assistance data message to the UE 702. The message may include specified assistance data for the UE 702 to perform the DL measurements.

At 724, the LMF 706 may send an LPP request location information message to the UE 702 to request multi-RTT measurements.

At 726, for semi-persistent or aperiodic UL SRS, the LMF 706 may request the serving base station 704 to activate/trigger the UL SRS in the UE 702. For example, the LMF 706 may request activation of UE SRS transmission by sending an NRPPa positioning activation request message to the serving base station 704.

At 728, the serving base station 704 may activate the UE SRS transmission and send an NRPPa positioning activation response message. In response, the UE 702 may begin the UL-SRS transmission according to the time domain behavior of UL SRS resource configuration.

At 730, the UE 702 may perform the DL measurements from the one or more candidate neighbor BSs/TRPs 708 and/or the serving base station 704 provided in the assistance data. At 732, each of the configured one or more candidate neighbor BSs/TRPs 708 and/or the serving base station 704 may perform the UL measurements.

At 734, the UE 702 may report the DL measurements to the LMF 706, such as via an LPP provide location information message.

At 736, each of the one or more candidate neighbor BSs/TRPs 708 and/or the serving base station 704 may report the UL measurements to the LMF 706, such as via an NRPPa measurement response message.

At 738, the LMF 706 may determine the RTTs from the UE 702 and BS/TRP Rx-Tx time difference measurements for each of the one or more candidate neighbor BSs/TRPs 708 and/or the serving base station 704 for which corresponding UL and DL measurements were provided at 734 and 736, and the LMF 706 may calculate the position of the UE 702.

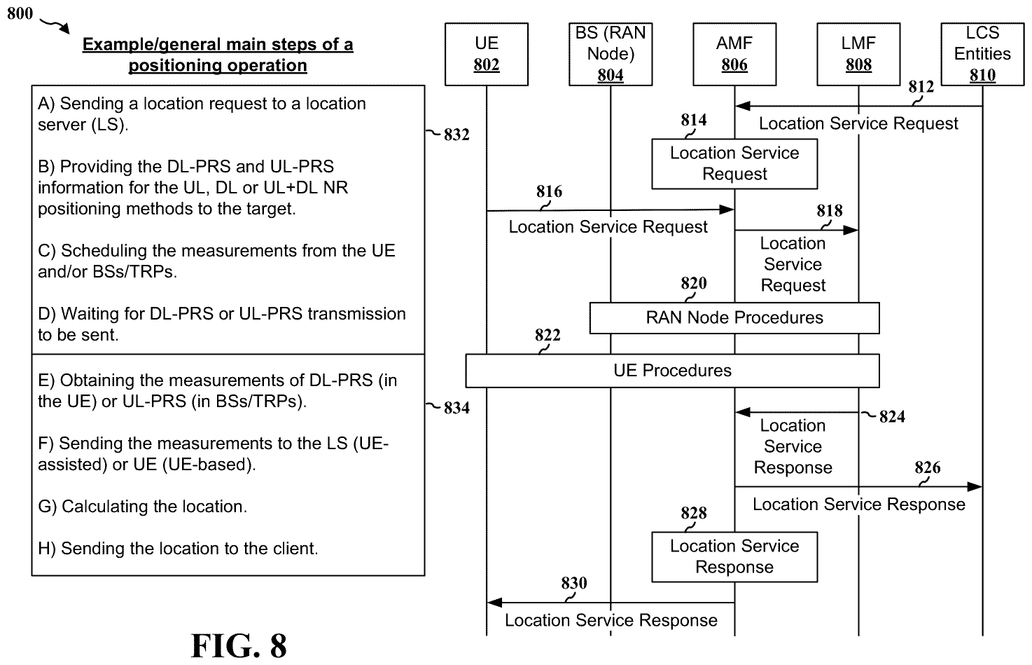

FIG. 8 is a communication flow 800 illustrating example main steps of a UE positioning operation in accordance with various aspects of the present disclosure. To support positioning of a target UE and delivery of location assistance data to a UE with RAN access (e.g., NG-RAN access in 5GS), location related functions may be distributed as shown in the communication flow 800. In some examples, if an AMF receives a location service request when a UE is in an idle state, the AMF may perform a network triggered service request in order to establish a signaling connection with the UE and assign a specific serving base station. As such, the UE may be assumed to be in a connected mode before the beginning of the flow shown in the communication flow 800, where signaling that may be specified to bring the UE to the connected mode may not be shown on the communication flow 800.

At 812, one or more location service entities 810 (e.g., gateway mobile location center (GMLC) in 5GC) may send a location service request (e.g., a UE positioning request) for a UE 802 to a serving AMF 806, or at 814, the serving AMF 806 for the UE 802 may determine that some location services may be specified for the UE 802 (e.g., to locate the UE 802 for an emergency call), or at 816, the UE 802 may send a location services request (e.g., for a positioning or delivery of assistance data) to the serving AMF 806, such as at the non-access stratum (NAS) level.

At 818, the AMF 806 may transfer the location service request to an LMF 808.

At 820, the LMF 808 may instigate location procedures with a serving base station 804 (e.g., a serving RAN node, ng-eNB or gNB in the NG-RAN) and possibly one or more neighboring RAN nodes as described in connection with FIG. 7, e.g., to obtain positioning measurements or assistance data.

At 822, in addition to 820 or instead of 820, the LMF 808 may instigate location procedures with the UE 802, e.g., to obtain a location estimate or positioning measurements or to transfer location assistance data to the UE 802. Steps described in connection with 820 and 822 may involve the use of different position methods to obtain location related measurements for the UE 802 and from these compute a location estimate and possibly additional information like velocity.

At 824, the LMF 808 may provide a location service response to the AMF 806 and includes any specified results, e.g., success or failure indication and, if specified and obtained, a location estimate for the UE 802.

At 826, if 812 was performed, the AMF 806 may return a location service response to the one or more location service entities 810 (e.g., the 5GC entity) and include any specified results, e.g., a location estimate for the UE 802.

At 828, if 814 occurred, the AMF 806 may use the location service response received in 824 to assist the service that triggered this in 814 (e.g., may provide a location estimate associated with an emergency call to a GMLC).

At 830, if 816 was performed, the AMF 806 may return a location service response to the UE 802 and includes any specified results, e.g., a location estimate for the UE 802.

As shown by the communication flow 800, the latency of a UE positioning operation may be associated with two delay components (or factors), such as a first delay component 832 (e.g., component A) and a second delay component 834 (e.g., component B). The first delay component 832 may include time delay prior to completion of location measurements, which may include sending a location request to a location server (LS) (e.g., the one or more location service entities 810), providing the DL-PRS and UL-PRS information for the UL, DL or UL+DL positioning methods to the target, scheduling the measurements from the UE 802 and/or base station 804, and/or waiting for DL-PRS or UL-PRS transmission to be sent, as described in connection with 812, 814, 816, 818, 820, and/or 822. The second delay component 834 may include delays associated with converting the location measurements into a location estimate and deliver this to a client, which may include obtaining the measurements of DL-PRS (in the UE) or UL-PRS (in BSs/TRPs), sending the measurements to the LS (e.g., for UE-assisted positioning) or the UE 802 (e.g., for UE-based positioning), calculating the location, and/or sending the location to the client, as described in connection with 820, 822, 824, 826, 828, and/or 830. In some examples, a very small latency for the second delay component 834 may enable a client to treat a location estimate as current as there may be little time for location degradation due to movement of the target UE.

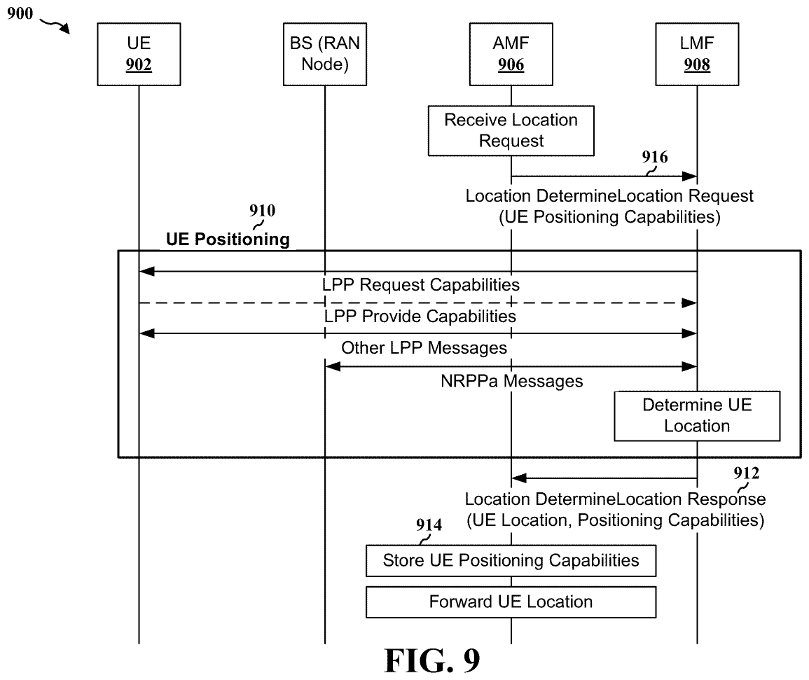

In some examples, to improve UE positioning latency, an AMF may be configured to store UE positioning capabilities of a UE, such that it may save time for a location server (e.g., an LMF) to request and receive the UE positioning capabilities from the UE. FIG. 9 is a communication flow 900 illustrating an example of an AMF storing UE positioning capabilities in accordance with various aspects of the present disclosure. In one example, as shown at 910, an LMF 908 may determine the position of a UE 902 in a UE positioning session (e.g., for a UE-assisted positioning), such as described in connection with 822 of FIG. 8. During the UE positioning session, the UE 902 may provide the LMF 908 with one or more UE positioning capabilities based on the LMF 908's request, such as described in connection with 710 of FIG. 7. At 912, after determining the position of the UE 902, the LMF 908 may report the position of the UE 902 and also the UE positioning capabilities received from the UE 902 to a serving AMF 906. At 914, the AMF 906 may store the UE positioning capabilities received. In other words, the LMF 908 may return the UE positioning capabilities to the AMF 906 along with the UE location when the UE positioning is complete. The AMF may then store the UE positioning capabilities and provide them to the LMF 908 for new location request(s) for the UE 902, such as at 916 of FIG. 9. For an initial location request, the AMF 906 may not be able to include the UE positioning capabilities of the UE 902 at 916, but the AMF 906 may be able to receive UE positioning capabilities from the LMF 908 at 912. Thus, the AMF 906 may then include the UE positioning capabilities at 916 for one or more later UE location requests.

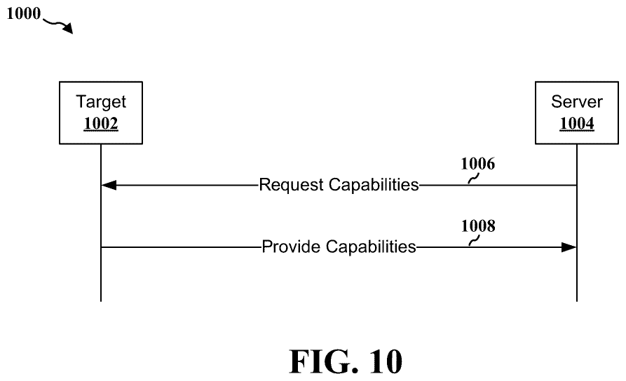

FIG. 10 is a communication flow 1000 illustrating an example capability transfer procedure (e.g., an LPP capability transfer procedure) in accordance with various aspects of the present disclosure. A target may transmit its positioning related capabilities to a server based on the server request. For example, at 1006, a server 1004 (e.g., an LMF or a LCS entity) may send a capability request message (e.g., a RequestCapabilities message) to a target 1002 (e.g., a UE). The server 1004 may indicate the types of capability reporting specified from the target 1002 in the capability request message. At 1008, in response to the capability request message, the target 1002 may respond with a capability response message (e.g., a Provide Capabilities message) to the server 1004. The positioning related capabilities included in the capability response message may correspond to any capability types specified at 1006. In some examples, the capability response message may also include a notification regarding the capability providing transaction has ended, such as by setting the endTransaction IE to TRUE.

As shown at 1006, after the target 1002 receives the capability request message from the server 1004 such as shown at 1006, the target 1002 may generate a response (e.g., a Provide Capabilities message) to the server. In some examples, for each positioning method for which a request for capabilities is included in the message: if the target device supports this positioning method: the response may include the capabilities of the target for that supported positioning method in the response message. The target 1002 may set the IE LPP-TransactionID in the response message to the same value as the IE LPP-TransactionID in the received message, and the target 1002 may deliver the response message to lower layers for transmission.

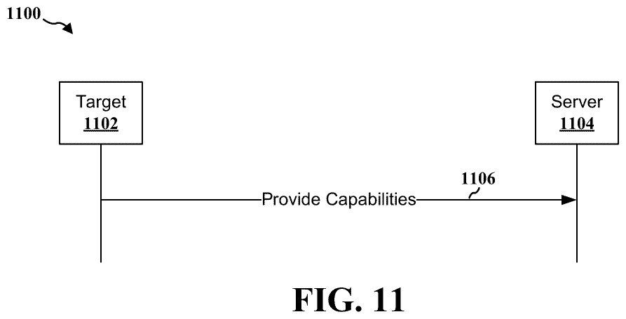

FIG. 11 is a communication flow 1100 illustrating an example capability indication procedure (e.g., an LPP capability indication procedure) in accordance with various aspects of the present disclosure. In some examples, a target may provide unsolicited positioning related capabilities to a server. For example, at 1106, a target 1102 (e.g., a UE) may send a capability message (e.g., a ProvideCapabilities message) to a server 1104 (e.g., an LMF or a LCS entity). In some examples, the capability message may also include a notification regarding the capability providing transaction has ended, such as by setting the endTransaction IE to TRUE.

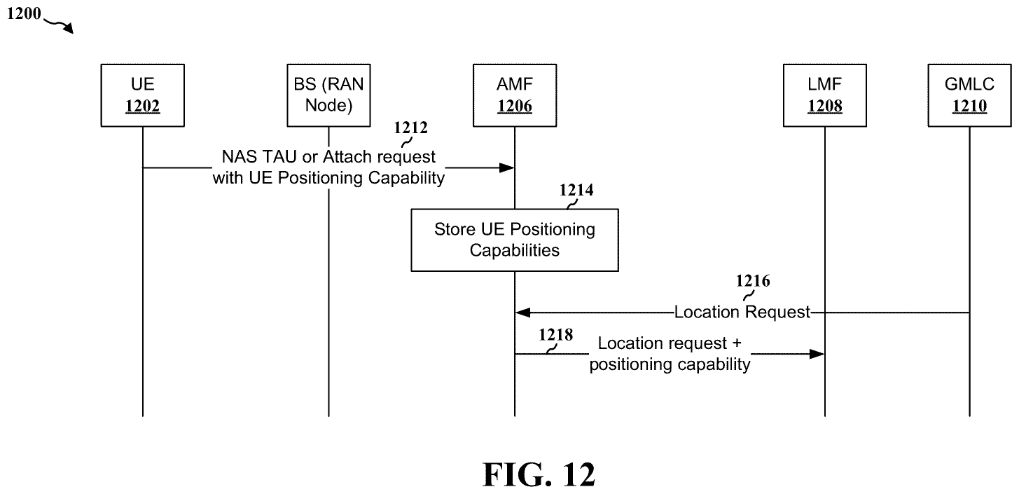

FIG. 12 is a communication flow 1200 illustrating an example of storing UE positioning capabilities at an AMF in accordance with various aspects of the present disclosure. As shown at 1212, a UE 1202 may provide its UE positioning capabilities to an AMF 1206 as part of a first attach procedure or after expiry of certain timer in a tracking area update message. Then, at 1214, the AMF 1206 may store the UE positioning capabilities received. At 1216, the AMF 1206 may receive a location request for the UE 1202 from a gateway mobile location center (GMLC) 1210 (e.g., an entity that may contain functionality specified to support location-based service (LBS)). At 1218, in response to the location request, the AMF 1206 may provide the location request received at 1216 and UE positioning capabilities stored at 1214 to a selected LMF 1208, such as described in connection with FIG. 9.

In some scenarios, the UE positioning capabilities reported by a UE may not always be static but may instead vary depending on the UE state, LMF capabilities and/or configuration(s) by a user. For example, the UE positioning capabilities reported by a UE may depend on an LMF, where the UE may not report capabilities that are not requested by the LMF. Thus, if a public land mobile network (PLMN) uses LMFs from different vendors or dedicated to different user cases (e.g., regulatory versus commercial), different UE positioning capabilities may be reported by the UE.

In another example, the UE positioning capabilities reported by a UE may depend on radio configuration, where UE positioning capabilities based on current/active radio configuration may not be static (e.g., the srs-PosResourceConfigCA-BandList may be provided for the current configured carrier aggregation (CA) band combination).

In another example, the UE positioning capabilities reported by a UE may depend on power savings. For example, a UE (e.g., an IoT device) whose battery level is low may switch off positioning support in order to conserve battery power for more important tasks such as communicating with an external server or may report lower processing capabilities (e.g., lower DL-PRS processing capabilities, or single-frequency GNSS capabilities instead of dual-frequency, or single-GNSS instead of multi-GNSS capabilities, etc.).

In another example, the UE positioning capabilities reported by a UE may depend on processing resources constraints. For example, the available processing resources (e.g., processors, memory, etc.) may be shared between “communication operation(s)” and “positioning operation(s).” If the communication operation(s) specify increased processing resources (for example, a large number of carriers to aggregate), the resources allocated to the positioning operation(s) may temporarily be reduced (e.g., lower DL-PRS processing capabilities, or single-frequency GNSS capabilities instead of dual-frequency, or single-GNSS instead of multi-GNSS capabilities, etc.).

In another example, the UE positioning capabilities reported by a UE may depend on privacy and/or user interaction. For example, a user may be allowed to disable location support for non-regulatory services (e.g., for a location request from an external non-regulatory LCS client). In such cases, when an LMF requests the positioning capabilities of the UE, the UE may reply with no positioning capabilities or with some limited minimal set of capabilities. An exception may apply if the UE is aware of an emergency services call where the UE may provide its full capability set to an LMF. In another example, a user may establish certain location areas and/or times of day where and/or when the UE may support location requests from a non-regulatory LCS client by sending a minimal or zero set of positioning capabilities to an LMF. An example of this case may be an employee at a hospital who allows accurate location during working hours but no location after hours.

In some scenarios, a UE may be aware or notified whether the UE positioning capabilities are being stored at an AMF, and the UE may also send different UE positioning capabilities to the network (e.g., to other entities of the network). In one example, all UE positioning capabilities reported from a UE may be stored, but the UE may be allowed to send different set of values (or conservative) values if the request is for capabilities that are to be stored to the network. In some examples, long-term UE positioning capabilities may be different than the short-term UE positioning capabilities. For example, a UE may report that it is capable of doing fewer PRS processing if a request for to-be-stored UE positioning capabilities is received, compared to a regular request for UE positioning capabilities. In another example, the UE may report two sets of capabilities, where one is associated with a flag that enables them to be stored, and another one may be a default set (e.g., a regular set, a legacy set) of capabilities. Such an option of reporting different values for the to-be-stored and the default capabilities may be available to a subset of feature groups or capabilities. For example, it may be available in the non-binary capabilities, whereas for binary (support or not a feature), the UE may be specified to use the reported capability for both types of capabilities.

In another example, a time-tag or expiration timer may be associated with the storing values (e.g., stored UE positioning capabilities), where the storing values may be deleted/removed from a server after the timer expires. In one example, the timer may be for the whole capability structure or there may be different expiration timers for different components/feature-groups. In another example, the time-tag may be a system frame number (SFN) or an index (which keeps incrementing and eventually wraps around). The index configuration may be more suitable than the SFN configuration in some cases as the index may be specified to increment once per capability update, which may be similar to the packet sequence number used in upper layers to address out-of-order delivery due to HARQ. In addition, there may be separate indexing for different subsets of the capabilities.

In another example, behavior of inter-LMF exchange of UE positioning capabilities may be standardized. For example, if all storage is at LMF, then the procedure may be transparent to AMF-change. All UE positioning capabilities may be transferred from an old LMF to a new LMF. In some examples, a capability transfer message may be defined for this purpose. For example, one or more generic message may be defined for this purpose, where these messages may be included in all the relevant protocols between relevant network nodes whenever the UE positioning capabilities are specified to report/move around. In some examples, this may be achieved in a containerized approach and/or by decode and forward approach. Which approach may be more suitable may depend on the network node that is receiving/transmitting the UE positioning capabilities, where the network node may be a base station, an AMF, an LMF, an LMF-in-RAN, etc.

In another example, a UE may send a default set of UE positioning capabilities (e.g., a legacy set of UE positioning capabilities) which are allowed to be stored, and then send a difference of the UE positioning capabilities, which may be referred to as delta capabilities, on a feature-group basis whenever a value in the stored UE positioning capabilities changes.

In some examples, as UE positioning capabilities may include static UE positioning capabilities and dynamic UE positioning capabilities, a network may be configured to store the static part of the UE positioning capabilities in the AMF. Then, for dynamic part of the UE positioning capabilities, an LMF may be specified to make the capability request to the UE (e.g., to request from the UE when specified). A CommonIEsProvideCapabilities message may be used for carrying common information elements (IEs) for a Provide Capabilities LPP message Type (e.g., as described in connection with 710 of FIG. 7 and/or 910 of FIG. 9). For example, a CommonIEsProvideCapabilities message may include a segmentationInfo field that indicates whether a ProvideCapabilities message is one of many segments. In another example, a CommonIEsProvideCapabilities message may include an lpp-message-segmentation that indicates a target device's LPP message segmentation capabilities. For example, if bit 0 is set to value 1, it may indicate that the target device supports receiving segmented LPP messages, whereas if bit 0 is set to value 0, it may indicate that the target device does not support receiving segmented LPP messages. In addition, if bit 1 is set to value 1, it may indicate that the target device supports sending segmented LPP messages, whereas if bit 1 is set to value 0, it may indicate that the target device does not support sending segmented LPP messages, etc.

In some scenarios, after a UE's positioning capabilities are stored at a network entity, such as at the AMF, the UE may not have the capability to support full positioning processing and capabilities stored all the time. For example, a UE may be specified to share common processing power (e.g., processor(s), memory, etc.) between radio mobility management (RMM) and positioning resources. As such, the UE may not be able to support full positioning processing and capabilities when the common processing power is shared with other entities. In another example, in a multi-SIM case, a UE may be specified to support one or more subscriber identification module (SIM) functions, where the UE may not be able to support full positioning processing and capabilities. In some instances, the support may be periodic, which means the UE may be specified to periodically downgrade the positioning capabilities. In another example, based on the battery status, a UE may determine to switch to lower processing capabilities, thereby making the UE unable to support full positioning processing and capabilities. In another example, based on the QoS, a UE may determine to upgrade and downgrades its positioning capabilities, etc. As such, a UE's UE positioning capabilities may change frequently.

Aspects presented herein may improve the performance and latency of UE positioning. Aspects presented herein may enable a UE to store multiple sets of UE processing capabilities at one or more network entities, such as at an AMF, an LMF, and/or another UE. Each of the multiple sets of UE processing capabilities may include a different level of UE positioning processing. As such, the UE may indicate to the one or more network entities which set of the UE processing capabilities to activate based on the UE's current processing availabilities/capabilities to improve positioning efficiency and latency.

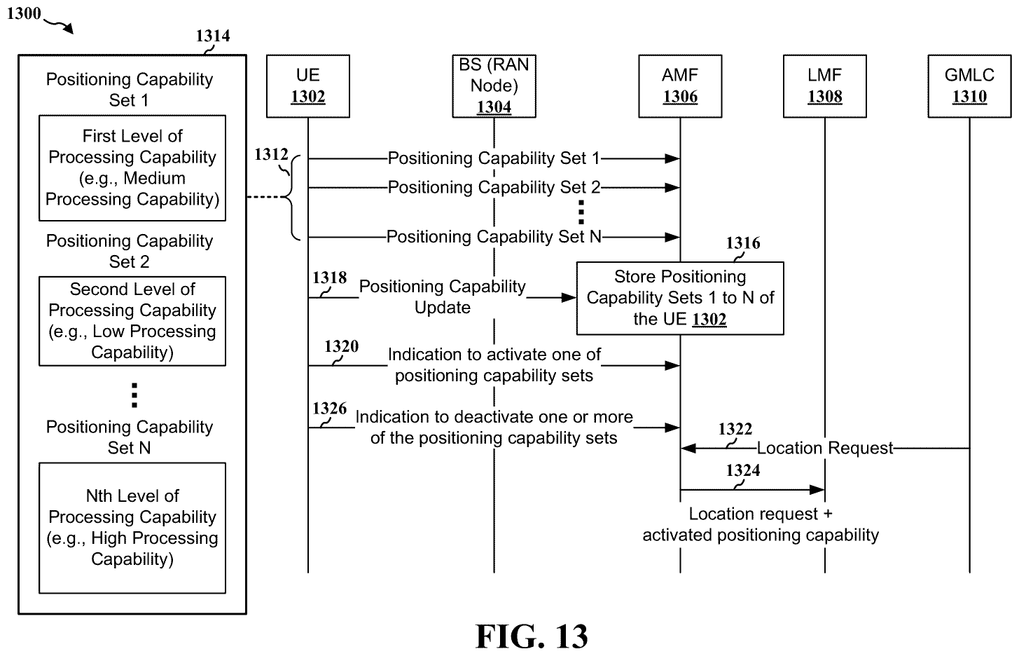

FIG. 13 is a communication flow 1300 illustrating an example of a UE storing multiple sets of UE processing capabilities at a network entity in accordance with various aspects of the present disclosure. The numberings associated with the communication flow 1300 do not specify a particular temporal order and are merely used as references for the communication flow 1300.

At 1312, a UE 1302 may transmit to an AMF 1306, one or more positioning capability sets that are associated with UE positioning processing, where each positioning capability set may correspond to a level of UE positioning processing that is different than another positioning capability set. For example, as shown at 1314, the positioning capability sets may include a first positioning capability set (capability set 1), a second positioning capability set (capability set 2), and up to N^{th} positioning capability set (capability set N). The first positioning capability set may be associated with a first level of processing capability (e.g., a medium processing capability), the second positioning capability set may be associated with a second level of processing capability (e.g., a low processing capability), and the N^{th} positioning capability set may be associated with an N^{th} level of processing capability (e.g., a high processing capability), etc.

In one example, at 1312, the UE 1302 may transmit all of the one or more positioning capability sets to the AMF 1306 at the same time (e.g., if the UE 1302 has the capability to determine all positioning capability sets, or the UE 1302 has information of all positioning use cases). For example, the UE 1302 may transmit positioning capability sets 1 to N to the AMF 1306 at the same time. In another example, the UE 1302 may transmit one capability set to the AMF 1306 at a time, such as a capability set that is used or configured for the UE 1302 at the time. For example, the UE 1302 may transmit the first positioning capability set to the AMF 1306 at a first point in time, transmit the second positioning capability set to the AMF 1306 at a second point in time, and transmit the N^{th} positioning capability set to the AMF 1306 at an N^{th} point in time, etc.

At 1316, after receiving the one or more positioning capability sets from the UE 1302, the AMF 1306 may store the received positioning capability sets in a database (e.g., a memory). In some examples, the UE 1302 may transmit the one or more positioning capability sets to a base station 1304 (e.g., a RAN node), and the AMF 1306 may receive the one or more positioning capability sets of the UE 1302 via the base station 1304.

At 1318, the UE 1302 may be configured to update the one or more of the positioning capability sets stored at the AMF 1306. For example, the UE 1302 may be configured to update the positioning capability sets stored at the AMF 1306 periodically (e.g., at a specified interval of times). In addition, the UE 1302 may update all of the stored positioning capability sets (e.g., update or replace positioning capability sets 1 to N with other positioning capability sets), or the UE 1302 may update a portion of the stored positioning capability sets (e.g., update positioning capability set one by one). In another example, the UE 1302 may be configured to update the one or more of the positioning capability sets stored at the AMF 1306 based on situation, such as when the UE 1302 is being specified to update, upon another positioning entity's request, and/or based on use cases, etc. Similarly, after receiving the updated positioning capability sets from the UE 1302, the AMF 1306 may store the updated positioning capability sets and delete the old positioning capability set(s) that are being updated/replaced.

In another aspect of the present disclosure, each or one or more of the positioning capability sets stored at the AMF 1306 may be associated with an expiration timer or a time tag, such that the AMF 1306 may delete a positioning capability set or a set of positioning capability set when their associated timer or time tag expires. For example, the first positioning capability set may be associated with an expiration timer that indicates the first positioning capability set is to be stored at the AMF 1306 for ten minutes. Then, after ten minutes, the AMF 1306 may delete/remove the first positioning capability set from its database. In another example, the positioning capability sets 1 to N may be associated with a time tag, which may be an SFN or an index that is configured to increment or decrement once per capability update or per a triggering event (e.g., a positioning session). Once the SFN or the index reaches a threshold (e.g., decremented to zero or incremented to a specified number), the AMF 1306 may delete/remove the positioning capability sets 1 to N from its database.

In some examples, the UE 1302 may be configured with a maximum number of positioning capability sets in which the UE 1302 may store at the AMF 1306 to conserve network resources and storage. For example, the UE 1302 may be configured to store up to N positioning capability sets at the AMF 1306. In one example, the maximum number of positioning capability sets in which the UE 1302 may store may be hard coded in a specification (e.g., predefined). In another example, the maximum number of positioning capability sets in which the UE 1302 may store may depend on the UE's category, classification, and/or processing capability. For example, a UE with a higher capability (e.g., a premier UE) may be provided with a higher maximum number of positioning capability sets in which the UE 1302 may store, and a UE with a lower capability (e.g., a reduced capability UE, a low cost UE, etc.) may be provided with a lower maximum number of positioning capability sets in which the UE 1302 may store. In another example, the maximum number of positioning capability sets in which the UE 1302 may store may depend on the positioning method or technology supported by the UE 1302. For example, if the UE 1302 supports OTDOA, TDOA, and/or multicell RTT positioning methods, the UE 1302 may be provided with a higher maximum number of positioning capability sets in which the UE 1302 may store compared to a UE that does not support such positioning methods. In another example, if the UE 1302 supports communication technology such as Industrial Internet-of-Things (IIOT), vehicle-to-everything (V2X), sidelink (SL), UE-UTRAN (Uu), the UE 1302 may be provided with a higher maximum number of positioning capability sets in which the UE 1302 may store compared to a UE that does not support such communication technology.

At 1320, after the UE 1302 stores one or more positioning capability sets at the AMF 1306, the UE 1302 may transmit an indication to the AMF 1306 regarding which of the one or more positioning capability sets to activate. In some examples, the UE 1302 may be configured to active just one of the multiple positioning capability set at a time (e.g., at any given time, just one capability set is activated). For example, after the UE 1302 stores the positioning capability sets 1 to N, the UE 1302 may send an indication to active the second positioning capability set (capability set 2) at 1320. As such, the UE 1302 may have the capability to control which positioning capability set to activate in the AMF 1306.

In some examples, the UE 1302 may be configured to periodically transmit the indication indicating which of the stored positioning capability sets to activate. In other words, which capability set to activate is updated periodically. In other examples, the UE 1302 may be configured to transmit the indication upon a triggering event, such as when there is a UE positioning session for the UE 1302. Similarly, the UE 1302 may send the indication to the AMF 1306 via the base station 1304. For example, the UE 1302 may transmit the indication to the base station 1304 via a lower layer signaling, such as uplink control information (UCI) and/or an uplink medium access control-control element (UL MAC-CE), etc. In another example, the UE 1302 may transmit the indication to the AMF 1306 via a higher layer signaling, such as in a transparent or a non-transparent fashion and passes it on the AMF 1306 along with a UE identity. In addition, the UE 1302 may transmit the indication prior to a UE positioning session (or independent of the UE positioning session).

At 1322, the AMF 1306 may receive a location request for the UE 1302 from the GMLC 1310, or from another positioning entity, or from the LMF 1308 itself.

At 1324, in response to the location request, the AMF 1306 may provide the location request (if the receiving entity is different from the requesting entity) and the positioning capability stored at the AMF 1306 and activated by the UE 1302 to the GMLC 1310 or the LMF 1308. For example, if the UE 1302 sent an indication to active the second positioning capability set (capability set 2) at 1320, then the AMF 1306 may send the second positioning capability set of the UE 1302 to the LMF 1308 at 1324. As such, the LMF 1308 may apply/configure the second positioning capability set for the location request (e.g., received at 1322).

In another aspect of the present disclosure, as shown at 1326, the UE 1302 may also be configured with a capability to deactivate or delete one or more of the positioning capability sets stored at the AMF 1306. For example, if the UE 1302 determines that it is not going to perform UE positioning for a certain period, the UE 1302 may send an indication to the AMF 1306 (or via the base station 1304) to deactivate all the positioning capability sets stored at the AMF 1306.

In some examples, the activation (e.g., at 1320) and deactivation (e.g., at 1326) of positioning capability set(s) may be configured to be independent of the positioning sessions. For example, at any given time, the UE 1302 may be able to change any of the positioning capability sets based on its local metric. In addition, activation of one of the positioning capability sets may happen much before the starting of a UE positioning session, such that the activation may not have impact on the positioning latency.

In another aspects of the present disclosure, when a UE positioning session configured for a UE is based on sidelink (SL) transmissions (e.g., the UE's positioning is determined based at least in part on reference signals transmitted via SL between the UE and at least one SL device), the UE may be configured to store one or more positioning capability sets at another UE (e.g., a sidelink device), at a serving base station, and/or at an LMF, etc., (which may collectively referring to as “positioning entities” or “SL positioning entities”). As such, the UE may activate one positioning capability set stored at one or more of these positioning entities, such that the one or more of these positioning entities may determine which positioning capability set to be applied/configured for the UE in a UE positioning session based on SL.

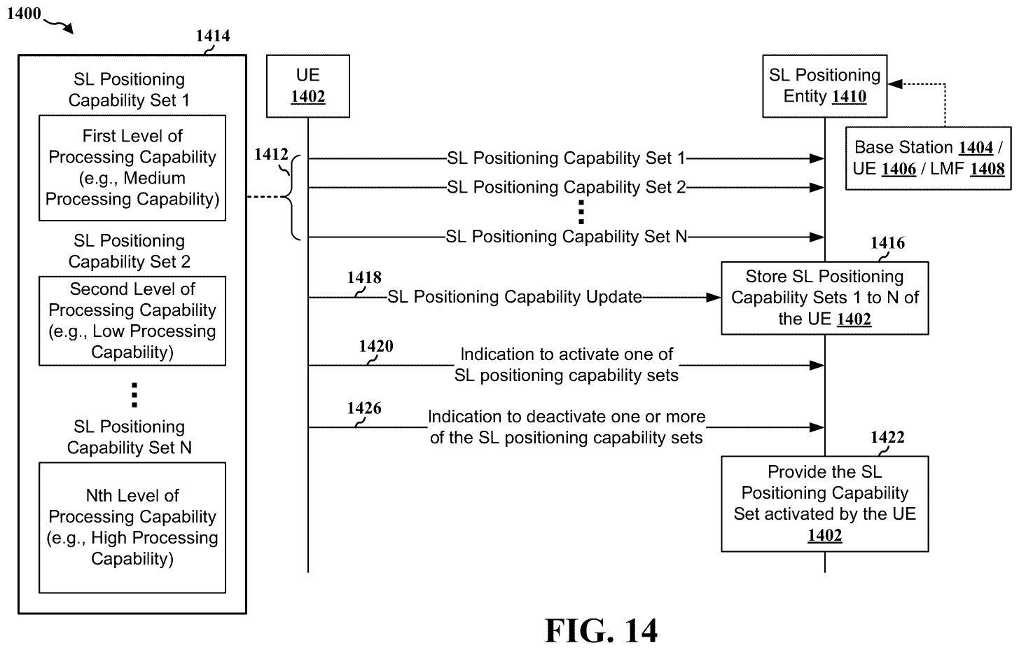

FIG. 14 is a communication flow 1400 illustrating an example of a UE storing multiple sets of UE SL processing capabilities at an SL positioning entity in accordance with various aspects of the present disclosure. The numberings associated with the communication flow 1400 do not specify a particular temporal order and are merely used as references for the communication flow 1400.

At 1412, a UE 1402 may transmit to an SL positioning entity 1410, one or more SL positioning capability sets that are associated with UE positioning processing for SL, where each SL positioning capability set may correspond to a level of UE positioning processing based on SL that is different than another SL positioning capability set. For example, as shown at 1414, the SL positioning capability sets may include a first SL positioning capability set (capability set 1), a second SL positioning capability set (capability set 2), and up to N^{th} SL positioning capability set (capability set N). The first SL positioning capability set may be associated with a first level of processing capability (e.g., a medium processing capability), the second SL positioning capability set may be associated with a second level of processing capability (e.g., a low processing capability), and the N^{th} SL positioning capability set may be associated with an N^{th} level of processing capability (e.g., a high processing capability), etc. The SL positioning entity 1410 may be a serving base station 1404, another UE 1406 (e.g., a sidelink UE), or an LMF 1408 that is associated with the UE positioning based on SL.

In one example, at 1412, the UE 1402 may transmit all of the one or more SL positioning capability sets to the SL positioning entity 1410 at the same time (e.g., if the UE 1402 has the capability to determine all SL positioning capability sets, or the UE 1402 has information of all positioning use cases). For example, the UE 1402 may transmit SL positioning capability sets 1 to N to the SL positioning entity 1410 at the same time. In another example, the UE 1402 may transmit one SL positioning capability set to the SL positioning entity 1410 at a time, such as a capability set that is used or configured for the UE 1402 at the time. For example, the UE 1402 may transmit the first SL positioning capability set to the SL positioning entity 1410 at a first point in time, transmit the second SL positioning capability set to the SL positioning entity 1410 at a second point in time, and transmit the N^{th} SL positioning capability set to the SL positioning entity 1410 at an N^{th} point in time, etc. In some examples, the UE 1402 may broadcast or groupcast the one or more SL positioning capability sets to a plurality of sidelink devices, which may include other UEs (e.g., the UE 1406).

At 1416, after receiving the one or more SL positioning capability sets from the UE 1402, the SL positioning entity 1410 may store the received SL positioning capability sets in a database (e.g., a memory). In some examples, the UE 1402 may transmit the one or more SL positioning capability sets to the SL positioning entity 1410 via another entity. For example, the UE 1402 may transmit the one or more SL positioning capability sets to the base station 1404 via the UE 1406, to the LMF 1408 via the base station 1404, or to a third UE via the UE 1406, etc.

At 1418, the UE 1402 may be configured to update the one or more of the SL positioning capability sets stored at the SL positioning entity 1410. For example, the UE 1402 may be configured to update the SL positioning capability sets stored at the SL positioning entity 1410 periodically (e.g., at a specified interval of times). In addition, the UE 1402 may update all of the stored SL positioning capability sets (e.g., update or replace SL positioning capability sets 1 to N with other SL positioning capability sets), or the UE 1402 may update a portion of the stored SL positioning capability sets (e.g., update SL positioning capability set one by one). In another example, the UE 1402 may be configured to update the one or more of the SL positioning capability sets stored at the SL positioning entity 1410 based on situation (e.g., a triggering event), such as when the UE 1402 is being specified to update, upon another positioning entity's request, and/or based on use cases, etc. Similarly, after receiving the updated SL positioning capability sets from the UE 1402, the SL positioning entity 1410 may store the updated SL positioning capability sets and delete the old SL positioning capability set(s) that are being updated/replaced.

In another aspect of the present disclosure, each or one or more of the SL positioning capability sets stored at the SL positioning entity 1410 may be associated with an expiration timer or a time tag, such that the SL positioning entity 1410 may delete a SL positioning capability set or a set of SL positioning capability set when their associated timer or time tag expires. For example, the first SL positioning capability set may be associated with an expiration timer that indicates the first SL positioning capability set is to be stored at the SL positioning entity 1410 for ten minutes. Then, after ten minutes, the SL positioning entity 1410 may delete/remove the first SL positioning capability set from its database. In another example, the SL positioning capability sets 1 to N may be associated with a time tag, which may be an SFN or an index that is configured to increment or decrement once per capability update or per a triggering event (e.g., a positioning session). Once the SFN or the index reaches a threshold (e.g., decremented to zero or incremented to a specified number), the SL positioning entity 1410 may delete/remove the SL positioning capability sets 1 to N from its database.

In some examples, the UE 1402 may be configured with a maximum number of SL positioning capability sets in which the UE 1402 may store at the SL positioning entity 1410 to conserve network resources and storage. For example, the UE 1402 may be configured to store up to N SL positioning capability sets at the SL positioning entity 1410. In one example, the maximum number of SL positioning capability sets in which the UE 1402 may store may be hard coded in a specification (e.g., predefined). In another example, the maximum number of SL positioning capability sets in which the UE 1402 may store may depend on the UE's category, classification, and/or processing capability. For example, a UE with a higher capability (e.g., a premier UE) may be provided with a higher maximum number of SL positioning capability sets in which the UE 1402 may store, and a UE with a lower capability (e.g., a reduced capability UE, a low cost UE, etc.) may be provided with a lower maximum number of SL positioning capability sets in which the UE 1402 may store. In another example, the maximum number of SL positioning capability sets in which the UE 1402 may store may depend on the positioning method or technology supported by the UE 1402. For example, if the UE 1402 supports OTDOA, TDOA, and/or multicell RTT positioning methods, the UE 1402 may be provided with a higher maximum number of SL positioning capability sets in which the UE 1402 may store compared to a UE that does not support such positioning methods. In another example, if the UE 1402 supports communication technology such as IIOT, V2X, SL, Uu, the UE 1402 may be provided with a higher maximum number of SL positioning capability sets in which the UE 1402 may store compared to a UE that does not support such communication technology.

At 1420, after the UE 1402 stores one or more SL positioning capability sets at the SL positioning entity 1410, the UE 1402 may transmit an indication to the SL positioning entity 1410 regarding which of the one or more SL positioning capability sets to activate. In some examples, the UE 1402 may be configured to active just one of the multiple SL positioning capability set at a time (e.g., at any given time, just one capability set is activated). For example, after the UE 1402 stores the SL positioning capability sets 1 to N, the UE 1402 may send an indication to active the second SL positioning capability set (capability set 2) at 1420. As such, the UE 1402 may have the capability to control which SL positioning capability set to activate in the SL positioning entity 1410.

In some examples, the UE 1402 may be configured to periodically transmit the indication indicating which of the stored SL positioning capability sets to activate. In other words, which capability set to activate may be updated periodically. In other examples, the UE 1402 may be configured to transmit the indication upon a triggering event, such as when there is a UE positioning session for the UE 1402. Similarly, the UE 1402 may send the indication to the SL positioning entity 1410 via another entity. For example, the UE 1402 may transmit the indication to the SL positioning entity 1410 via a higher layer signaling, such as sidelink control information (SCI) and/or SL MAC-CE. In other example, the indication may be broadcasted/groupcasted by the UE 1402.

At 1422, the SL positioning entity 1410 may receive a location request (e.g., based on SL UE positioning) for the UE 1402 from another positioning entity, and in response to the location request, the SL positioning entity 1410 may provide the location request (if the receiving entity is different from the requesting entity) and/or the SL positioning capability set stored at the SL positioning entity 1410 and activated by the UE 1402 to another positioning entity (e.g., which may be the positioning entity sending the location request). For example, if the UE 1402 sent an indication to active the second SL positioning capability set (capability set 2) at 1420, then the SL positioning entity 1410 may send the second SL positioning capability set of the UE 1402 to another positioning entity at 1422. As such, the other positioning entity may apply/configure the second SL positioning capability set for the location request.

In another aspect of the present disclosure, as shown at 1426, the UE 1402 may also be configured with a capability to deactivate or delete one or more of the SL positioning capability sets stored at the SL positioning entity 1410. For example, if the UE 1402 determines that it is not going to perform UE positioning for a certain period, the UE 1402 may send an indication to the SL positioning entity 1410 (or via another entity) to deactivate all the SL positioning capability sets stored at the SL positioning entity 1410.

In some examples, the activation (e.g., at 1420) and deactivation (e.g., at 1426) of SL positioning capability set(s) may be configured to be independent of the positioning sessions. For example, at any given time, the UE 1402 may be able to change any of the SL positioning capability sets based on its local metric. In addition, activation of one of the SL positioning capability sets may happen much before the starting of a UE positioning session, such that the activation may not have impact on the positioning latency.

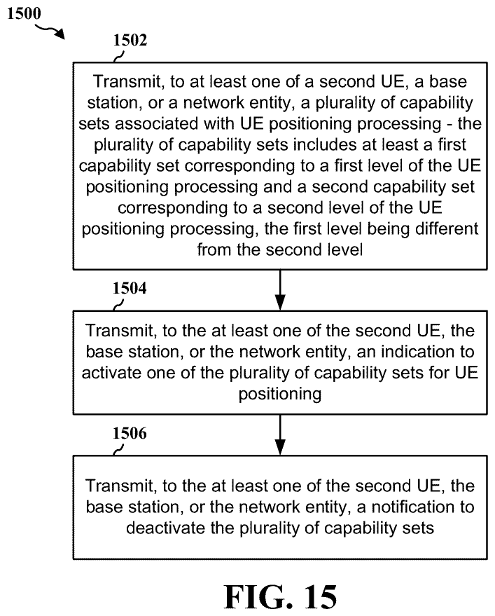

FIG. 15 is a flowchart 1500 of a method of wireless communication. The method may be performed by a UE or a component of a UE (e.g., the UE 104, 350, 404, 602, 702, 802, 902, 1202, 1302, 1402; the apparatus 1702; a processing system, which may include the memory 376 and which may be the entire base station 310 or a component of the base station 310, such as the TX processor 316 the RX processor 370, and/or the controller/processor 375). The method may enable the UE to store multiple sets of UE processing capabilities at one or more network entities, and to activate one set of the stored UE processing capabilities based on the UE's current processing availabilities/capabilities to improve positioning efficiency and latency.

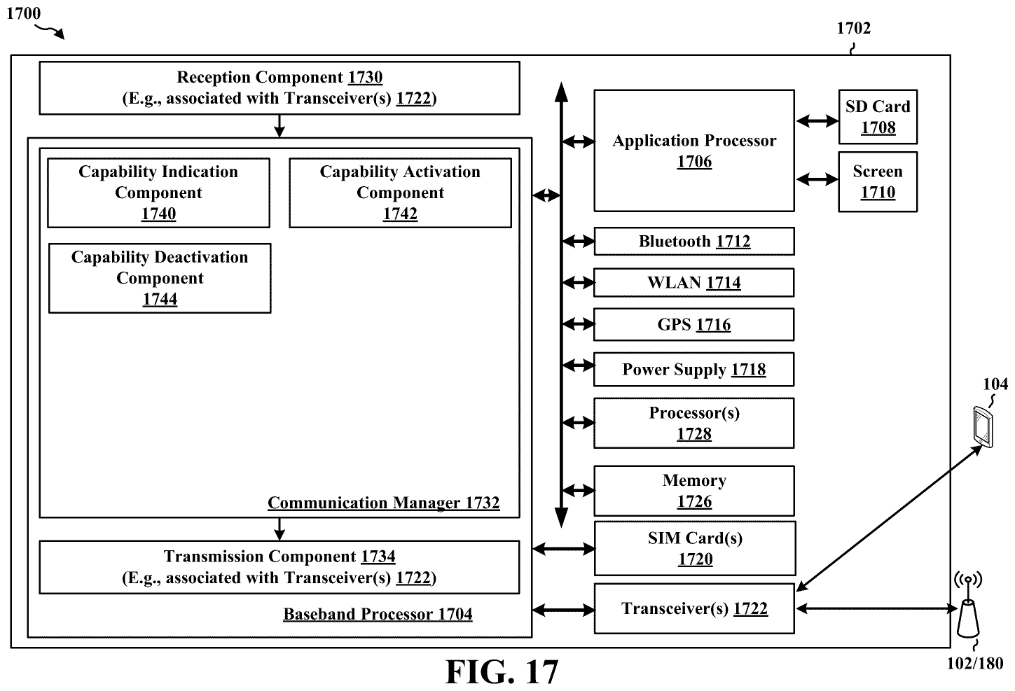

At 1502, the UE may transmit, to at least one of a second UE, a base station, or a network entity, a plurality of capability sets associated with UE positioning processing, the plurality of capability sets including at least a first capability set corresponding to a first level of the UE positioning processing and a second capability set corresponding to a second level of the UE positioning processing, the first level being different from the second level, such as described in connection with FIGS. 13 and 14. For example, at 1312, the UE 1302 may transmit, to an AMF 1306, a plurality of positioning capability sets associated with UE positioning processing. As shown at 1314, the plurality of capability sets may include at least a first capability set corresponding to a first level of the UE positioning processing and a second capability set corresponding to a second level of the UE positioning processing, the first level being different from the second level. The transmission of the plurality of capability sets associated with UE positioning processing may be performed by, e.g., the capability indication component 1740 and/or the transmission component 1734 of the apparatus 1702 in FIG. 17.

At 1504, the UE may transmit, to the at least one of the second UE, the base station, or the network entity, an indication to activate one of the plurality of capability sets for UE positioning, such as described in connection with FIGS. 13 and 14. For example, at 1320, the UE 1302 may transmit, to the AMF 1306, an indication to activate one of the plurality of capability sets for UE positioning. The transmission of the indication to activate one of the plurality of capability sets for UE positioning may be performed by, e.g., the capability activation component 1742 and/or the transmission component 1734 in FIG. 17.

In one example, the plurality of capability sets may be transmitted to the network entity, the network entity being an AMF. In such an example, one or more of the plurality of capability sets may be transmitted to the AMF via the base station, or the indication may be transmitted to the AMF via the base station. In such an example, the indication may be transmitted via a lower layer signaling, UCI, or an UL MAC-CE.

In another example, the plurality of capability sets may be transmitted to the at least one of the second UE, the base station, or the network entity, the network entity being an LMF and the plurality of capability sets being associated with SL UE positioning processing. In such an example, the indication may be transmitted via a higher layer signaling, SCI, or SL MAC-CE. In such an example, the plurality of capability sets may be broadcasted or groupcasted to a plurality of sidelink devices including the second UE.

In another example, the indication may be transmitted periodically or updated periodically.

In another example, the plurality of capability sets may be transmitted at a same time.

In another example, the first capability set and the second capability set may be transmitted at a different time. In such an example, the UE may transmit, to the at least one of the second UE, the base station, or the network entity, a third capability set corresponding to a third level of the UE positioning processing, where the third level may be different from the first level and the second level.

In another example, the plurality of capability sets may be stored at the at least one of the second UE, the base station, or the network entity, each of the plurality of capability sets may be associated with a timer that indicates a time in which a capability set is to be stored, such that the capability set is removed from the at least one of the second UE, the base station, or the network entity in response to the timer expiring.

In another example, no more than one capability set of the plurality of capability sets is to be activated at a time.

In another example, the indication may be transmitted prior to a UE positioning session.

At 1506, the UE may transmit, to the at least one of the second UE, the base station, or the network entity, a notification to deactivate the plurality of capability sets, such as described in connection with FIGS. 13 and 14. For example, at 1326, the UE 1302 may transmit, to the AMF 1306, a notification to deactivate the plurality of capability sets. The transmission of the notification to deactivate the plurality of capability sets may be performed by, e.g., the capability deactivation component 1744 and/or the transmission component 1734 in FIG. 17.

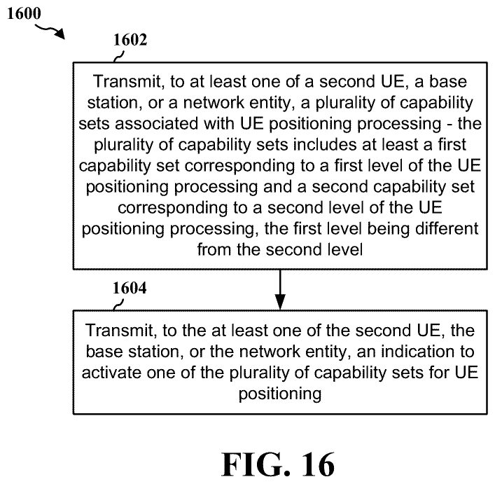

FIG. 16 is a flowchart 1600 of a method of wireless communication. The method may be performed by a UE or a component of a UE (e.g., the UE 104, 350, 404, 602, 702, 802, 902, 1202, 1302, 1402; the apparatus 1702; a processing system, which may include the memory 376 and which may be the entire base station 310 or a component of the base station 310, such as the TX processor 316 the RX processor 370, and/or the controller/processor 375). The method may enable the UE to store multiple sets of UE processing capabilities at one or more network entities, and to activate one set of the stored UE processing capabilities based on the UE's current processing availabilities/capabilities to improve positioning efficiency and latency.

At 1602, the UE may transmit, to at least one of a second UE, a base station, or a network entity, a plurality of capability sets associated with UE positioning processing, the plurality of capability sets including at least a first capability set corresponding to a first level of the UE positioning processing and a second capability set corresponding to a second level of the UE positioning processing, the first level being different from the second level, such as described in connection with FIGS. 13 and 14. For example, at 1312, the UE 1302 may transmit, to an AMF 1306, a plurality of positioning capability sets associated with UE positioning processing. As shown at 1314, the plurality of capability sets may include at least a first capability set corresponding to a first level of the UE positioning processing and a second capability set corresponding to a second level of the UE positioning processing, the first level being different from the second level. The transmission of the plurality of capability sets associated with UE positioning processing may be performed by, e.g., the capability indication component 1740 and/or the transmission component 1734 of the apparatus 1702 in FIG. 17.

At 1604, the UE may transmit, to the at least one of the second UE, the base station, or the network entity, an indication to activate one of the plurality of capability sets for UE positioning, such as described in connection with FIGS. 13 and 14. For example, at 1320, the UE 1302 may transmit, to the AMF 1306, an indication to activate one of the plurality of capability sets for UE positioning. The transmission of the indication to activate one of the plurality of capability sets for UE positioning may be performed by, e.g., the capability activation component 1742 and/or the transmission component 1734 in FIG. 17.

In one example, the plurality of capability sets may be transmitted to the network entity, the network entity being an AMF. In such an example, one or more of the plurality of capability sets may be transmitted to the AMF via the base station, or the indication may be transmitted to the AMF via the base station. In such an example, the indication may be transmitted via a lower layer signaling, UCI, or an UL MAC-CE.

In another example, the plurality of capability sets may be transmitted to the at least one of the second UE, the base station, or the network entity, the network entity being an LMF and the plurality of capability sets being associated with SL UE positioning processing. In such an example, the indication may be transmitted via a higher layer signaling, SCI, or SL MAC-CE. In such an example, the plurality of capability sets may be broadcasted or groupcasted to a plurality of sidelink devices including the second UE.

In another example, the indication may be transmitted periodically or updated periodically.

In another example, the plurality of capability sets may be transmitted at a same time.

In another example, the first capability set and the second capability set may be transmitted at a different time. In such an example, the UE may transmit, to the at least one of the second UE, the base station, or the network entity, a third capability set corresponding to a third level of the UE positioning processing, where the third level may be different from the first level and the second level.

In another example, the plurality of capability sets may be stored at the at least one of the second UE, the base station, or the network entity, each of the plurality of capability sets may be associated with a timer that indicates a time in which a capability set is to be stored, such that the capability set is removed from the at least one of the second UE, the base station, or the network entity in response to the timer expiring.

In another example, no more than one capability set of the plurality of capability sets is to be activated at a time.

In another example, the indication may be transmitted prior to a UE positioning session.

In another example, the UE may transmit, to the at least one of the second UE, the base station, or the network entity, a notification to deactivate the plurality of capability sets, such as described in connection with FIGS. 13 and 14. For example, at 1326, the UE 1302 may transmit, to the AMF 1306, a notification to deactivate the plurality of capability sets. The transmission of the notification to deactivate the plurality of capability sets may be performed by, e.g., the capability deactivation component 1744 and/or the transmission component 1734 in FIG. 17.

FIG. 17 is a diagram 1700 illustrating an example of a hardware implementation for an apparatus 1702. The apparatus 1702 may be a UE, a component of a UE, or may implement UE functionality. In some aspects, the apparatus 1702 may include a baseband processor 1704 (also referred to as a modem) coupled to at least one transceiver 1722 (e.g., one or more RF transceivers and/or antennas). The at least one transceiver 1722 may be associated with or include a reception component 1730 and/or a transmission component 1734. In some aspects, the apparatus 1702 may further include one or more subscriber identity modules (SIM) cards 1720, an application processor 1706 coupled to a secure digital (SD) card 1708 and a screen 1710, a Bluetooth module 1712, a wireless local area network (WLAN) module 1714, a Global Positioning System (GPS) module 1716, or a power supply 1718. The baseband processor 1704 communicates through the at least one transceiver 1722 with the UE 104, BS 102/180, an AMF, and/or an LMF. The baseband processor 1704 may include a computer-readable medium/memory (e.g., a memory 1726). The computer-readable medium/memory may be non-transitory. The baseband processor 1704 and/or at least one processor 1728 is responsible for general processing, including the execution of software stored on the computer-readable medium/memory. The software, when executed by the baseband processor 1704 and/or the at least one processor 1728, causes the baseband processor 1704 and/or the at least one processor 1728 to perform the various functions described supra. The computer-readable medium/memory may also be used for storing data that is manipulated by the baseband processor 1704 when executing software. The baseband processor 1704 further includes the reception component 1730, a communication manager 1732, and the transmission component 1734. The reception component 1730 and the transmission component 1734 may, in a non-limiting example, include at least one transceiver and/or at least one antenna subsystem. The communication manager 1732 includes the one or more illustrated components. The components within the communication manager 1732 may be stored in the computer-readable medium/memory and/or configured as hardware within the baseband processor 1704. The baseband processor 1704 may be a component of the UE 350 and may include the memory 360 and/or at least one of the TX processor 368, the RX processor 356, and the controller/processor 359. In one configuration, the apparatus 1702 may be a modem chip and include just the baseband processor 1704, and in another configuration, the apparatus 1702 may be the entire UE (e.g., see 350 of FIG. 3) and include the additional modules of the apparatus 1702.

The communication manager 1732 includes a capability indication component 1740 that is configured to transmit, to at least one of a second UE, a base station, or a network entity, a plurality of capability sets associated with UE positioning processing, the plurality of capability sets including at least a first capability set corresponding to a first level of the UE positioning processing and a second capability set corresponding to a second level of the UE positioning processing, the first level being different from the second level, e.g., as described in connection with 1502 of FIG. 15 and/or 1602 of FIG. 16. The communication manager 1732 further includes a capability activation component 1742 that is configured to transmit, to the at least one of the second UE, the base station, or the network entity, an indication to activate one of the plurality of capability sets for UE positioning, e.g., as described in connection with 1504 of FIG. 15 and/or 1604 of FIG. 16. The communication manager 1732 further includes a capability deactivation component 1744 that is configured to transmit, to the at least one of the second UE, the base station, or the network entity, a notification to deactivate the plurality of capability sets, e.g., as described in connection with 1506 of FIG. 15.

The apparatus may include additional components that perform each of the blocks of the algorithm in the flowcharts of FIGS. 15 and 16. As such, each block in the flowcharts of FIGS. 15 and 16 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

As shown, the apparatus 1702 may include a variety of components configured for various functions. In one configuration, the apparatus 1702, and in particular the baseband processor 1704, includes means for transmitting, to at least one of a second UE, a base station, or a network entity, a plurality of capability sets associated with UE positioning processing, the plurality of capability sets including at least a first capability set corresponding to a first level of the UE positioning processing and a second capability set corresponding to a second level of the UE positioning processing, the first level being different from the second level (e.g., the capability indication component 1740 and/or the transmission component 1734). The apparatus 1702 includes means for transmitting, to the at least one of the second UE, the base station, or the network entity, an indication to activate one of the plurality of capability sets for UE positioning (e.g., the capability activation component 1742 and/or the transmission component 1734). The apparatus 1702 includes means for transmitting, to the at least one of the second UE, the base station, or the network entity, a notification to deactivate the plurality of capability sets (e.g., the capability deactivation component 1744 and/or the transmission component 1734).

In one configuration, the plurality of capability sets may be transmitted to the network entity, the network entity being an AMF. In such a configuration, one or more of the plurality of capability sets may be transmitted to the AMF via the base station, or the indication may be transmitted to the AMF via the base station. In such a configuration, the indication may be transmitted via a lower layer signaling, UCI, or an UL MAC-CE.

In another configuration, the plurality of capability sets may be transmitted to the at least one of the second UE, the base station, or the network entity, the network entity being an LMF and the plurality of capability sets being associated with SL UE positioning processing. In such a configuration, the indication may be transmitted via a higher layer signaling, SCI, or SL MAC-CE. In such a configuration, the plurality of capability sets may be broadcasted or groupcasted to a plurality of sidelink devices including the second UE.

In another configuration, the indication may be transmitted periodically or updated periodically.

In another configuration, the plurality of capability sets may be transmitted at a same time.

In another configuration, the first capability set and the second capability set may be transmitted at a different time. In such a configuration, the apparatus 1702 includes means for transmitting, to the at least one of the second UE, the base station, or the network entity, a third capability set corresponding to a third level of the UE positioning processing, where the third level may be different from the first level and the second level.

In another configuration, the plurality of capability sets may be stored at the at least one of the second UE, the base station, or the network entity, each of the plurality of capability sets may be associated with a timer that indicates a time in which a capability set is to be stored, such that the capability set is removed from the at least one of the second UE, the base station, or the network entity in response to the timer expiring.

In another configuration, no more than one capability set of the plurality of capability sets is to be activated at a time.

In another configuration, the indication may be transmitted prior to a UE positioning session.

The means may be one or more of the components of the apparatus 1702 configured to perform the functions recited by the means. As described supra, the apparatus 1702 may include the TX Processor 368, the RX Processor 356, and the controller/processor 359. As such, in one configuration, the means may be the TX Processor 368, the RX Processor 356, and the controller/processor 359 configured to perform the functions recited by the means. Alternatively, the means may be the TX Processor 316, the RX Processor 370, and the controller/processor 375 configured to perform the functions recited by the means.

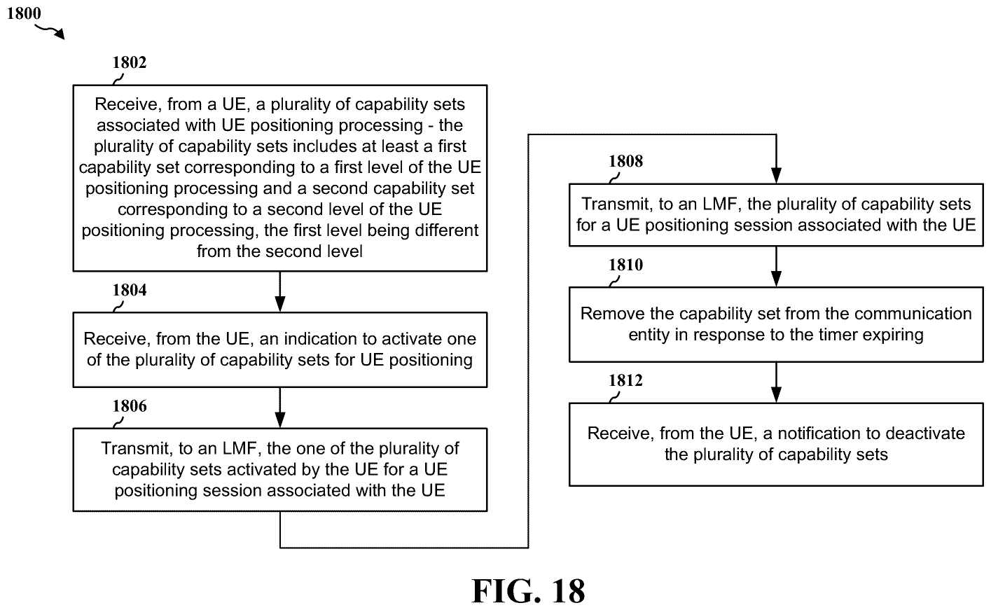

FIG. 18 is a flowchart 1800 of a method of wireless communication. The method may be performed by a communication entity or a component of a communication entity (e.g., the base station 102, 180, 310, 1304, 1404; the UE 1406; the AMF 1306; the LMF 1308, 1408; the GMLC 1310; the apparatus 2002; a processing system, which may include the memory 376 and which may be the entire base station 310 or a component of the base station 310, such as the TX processor 316 the RX processor 370, and/or the controller/processor 375). The method may enable the communication entity to store multiple sets of UE processing capabilities for a UE, and to activate one set of the stored UE processing capabilities for the UE based on the UE's indication.

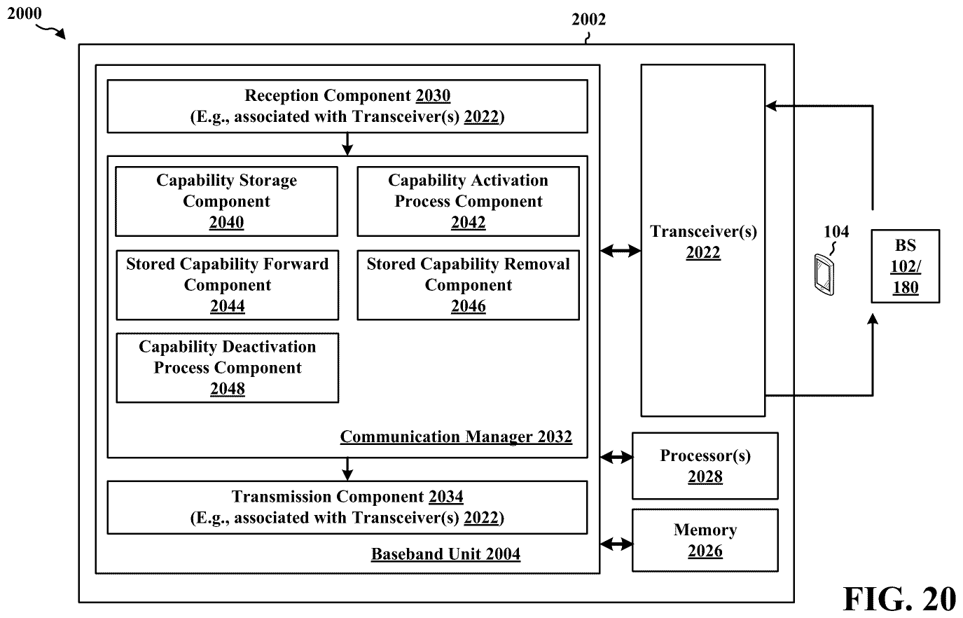

At 1802, the communication entity may receive, from a UE, a plurality of capability sets associated with UE positioning processing, the plurality of capability sets including at least a first capability set corresponding to a first level of the UE positioning processing and a second capability set corresponding to a second level of the UE positioning processing, the first level being different from the second level, such as described in connection with FIGS. 13 and 14. For example, at 1312, the AMF 1306 may receive, from the UE 1302, a plurality of capability sets associated with UE positioning processing, the plurality of capability sets may include at least a first capability set corresponding to a first level of the UE positioning processing and a second capability set corresponding to a second level of the UE positioning processing, the first level being different from the second level, such as shown at 1314. The reception of the plurality of capability sets associated with UE positioning processing may be performed by, e.g., the capability storage component 2040 and/or the reception component 2030 of the apparatus 2002 in FIG. 20.

At 1804, the communication entity may receive, from the UE, an indication to activate one of the plurality of capability sets for UE positioning, such as described in connection with FIGS. 13 and 14. For example, at 1320, the AMF 1306 may receive, from the UE 1302, an indication to activate one of the plurality of capability sets for UE positioning. The reception of the indication to activate one of the plurality of capability sets for UE positioning may be performed by, e.g., the capability activation process component 2042 and/or the reception component 2030 of the apparatus 2002 in FIG. 20.

In one example, one or more of the plurality of capability sets may be received from the UE via a base station, or the indication may be received from the UE via a base station.

In another example, the communication entity may be an AMF, a sidelink UE, a base station, or an LMF. In such an example, the indication may be received via a lower layer signaling, UCI, an UL MAC-CE if the communication entity is the AMF. In such an example, the indication may be received via a higher layer signaling, SCI, or SL MAC-CE if the communication entity is the sidelink UE, the base station, or the LMF.

In another example, the indication may be received periodically.

In another example, the plurality of capability sets may be received at a same time.

In another example, the first capability set and the second capability set may be received at a different time. In such an example, the communication entity may receive, from the UE, a third capability set corresponding to a third level of the UE positioning processing, where the third level is different from the first level and the second level.

In another example, no more than one capability set of the plurality of capability sets may be activated at a time.

In another example, the indication may be received prior to a UE positioning session.

In another example, the plurality of capability sets may be stored at the communication entity, each of the plurality of capability sets being associated with a timer that indicates a time in which a capability set is to be stored. In such an example, at 1806, the communication entity may transmit, to an LMF, the one of the plurality of capability sets activated by the UE for a UE positioning session associated with the UE, such as described in connection with FIGS. 13 and 14. For example, at 1324, the AMF may transmit, to the LMF 1308, the one of the plurality of capability sets activated by the UE 1302 for a UE positioning session associated with the UE 1302. The transmission of the one of the plurality of capability sets activated by the UE may be performed by, e.g., the stored capability forward component 2044 and/or the transmission component 2034 of the apparatus 2002 in FIG. 20.

At 1808, the communication entity may transmit, to an LMF, the plurality of capability sets for a UE positioning session associated with the UE, such as described in connection with FIGS. 13 and 14. at 1324, the AMF may transmit, to the LMF 1308, the plurality of capability sets for a UE positioning session associated with the UE 1302. The transmission of the plurality of capability sets may be performed by, e.g., the stored capability forward component 2044 and/or the transmission component 2034 of the apparatus 2002 in FIG. 20.

At 1810, the communication entity may remove the capability set from the communication entity in response to the timer expiring, such as described in connection with FIGS. 13 and 14. For example, the AMF 1306 may remove the capability set from the AMF 1306 in response to a timer associated with the capability set expiring. The removal of the capability set may be performed by, e.g., the stored capability removal component 2046 of the apparatus 2002 in FIG. 20.

At 1812, the communication entity may receive, from the UE, a notification to deactivate the plurality of capability sets, such as described in connection with FIGS. 13 and 14. For example, at 1326, the AMF 1306 may receive, from the UE 1302, a notification to deactivate the plurality of capability sets. The reception of the notification to deactivate the plurality of capability sets may be performed by, e.g., the capability deactivation process component 2048 and/or the reception component 2030 of the apparatus 2002 in FIG. 20.

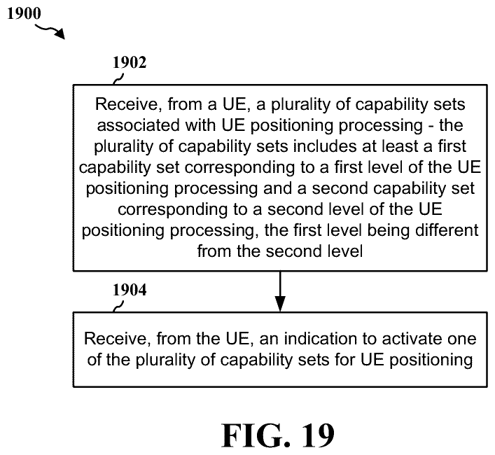

FIG. 19 is a flowchart 1900 of a method of wireless communication. The method may be performed by a communication entity or a component of a communication entity (e.g., the base station 102, 180, 310, 1304, 1404; the UE 1406; the AMF 1306; the LMF 1308, 1408; the GMLC 1310; the apparatus 2002; a processing system, which may include the memory 376 and which may be the entire base station 310 or a component of the base station 310, such as the TX processor 316 the RX processor 370, and/or the controller/processor 375). The method may enable the communication entity to store multiple sets of UE processing capabilities for a UE, and to activate one set of the stored UE processing capabilities for the UE based on the UE's indication.

At 1902, the communication entity may receive, from a UE, a plurality of capability sets associated with UE positioning processing, the plurality of capability sets including at least a first capability set corresponding to a first level of the UE positioning processing and a second capability set corresponding to a second level of the UE positioning processing, the first level being different from the second level, such as described in connection with FIGS. 13 and 14. For example, at 1312, the AMF 1306 may receive, from the UE 1302, a plurality of capability sets associated with UE positioning processing, the plurality of capability sets may include at least a first capability set corresponding to a first level of the UE positioning processing and a second capability set corresponding to a second level of the UE positioning processing, the first level being different from the second level, such as shown at 1314. The reception of the plurality of capability sets associated with UE positioning processing may be performed by, e.g., the capability storage component 2040 and/or the reception component 2030 of the apparatus 2002 in FIG. 20.

At 1904, the communication entity may receive, from the UE, an indication to activate one of the plurality of capability sets for UE positioning, such as described in connection with FIGS. 13 and 14. For example, at 1320, the AMF 1306 may receive, from the UE 1302, an indication to activate one of the plurality of capability sets for UE positioning. The reception of the indication to activate one of the plurality of capability sets for UE positioning may be performed by, e.g., the capability activation process component 2042 and/or the reception component 2030 of the apparatus 2002 in FIG. 20.

In one example, one or more of the plurality of capability sets may be received from the UE via a base station, or the indication may be received from the UE via a base station.

In another example, the communication entity may be an AMF, a sidelink UE, a base station, or an LMF. In such an example, the indication may be received via a lower layer signaling, UCI, an UL MAC-CE if the communication entity is the AMF. In such an example, the indication may be received via a higher layer signaling, SCI, or SL MAC-CE if the communication entity is the sidelink UE, the base station, or the LMF.

In another example, the indication may be received periodically.

In another example, the plurality of capability sets may be received at a same time.

In another example, the first capability set and the second capability set may be received at a different time. In such an example, the communication entity may receive, from the UE, a third capability set corresponding to a third level of the UE positioning processing, where the third level is different from the first level and the second level.

In another example, no more than one capability set of the plurality of capability sets may be activated at a time.

In another example, the indication may be received prior to a UE positioning session.

In another example, the plurality of capability sets may be stored at the communication entity, each of the plurality of capability sets being associated with a timer that indicates a time in which a capability set is to be stored. In such an example, the communication entity may transmit, to an LMF, the one of the plurality of capability sets activated by the UE for a UE positioning session associated with the UE, such as described in connection with FIGS. 13 and 14. For example, at 1324, the AMF may transmit, to the LMF 1308, the one of the plurality of capability sets activated by the UE 1302 for a UE positioning session associated with the UE 1302. The transmission of the one of the plurality of capability sets activated by the UE may be performed by, e.g., the stored capability forward component 2044 and/or the transmission component 2034 of the apparatus 2002 in FIG. 20.

In another example, the communication entity may transmit, to an LMF, the plurality of capability sets for a UE positioning session associated with the UE, such as described in connection with FIGS. 13 and 14. at 1324, the AMF may transmit, to the LMF 1308, the plurality of capability sets for a UE positioning session associated with the UE 1302. The transmission of the plurality of capability sets may be performed by, e.g., the stored capability forward component 2044 and/or the transmission component 2034 of the apparatus 2002 in FIG. 20.

In another example, the communication entity may remove the capability set from the communication entity in response to the timer expiring, such as described in connection with FIGS. 13 and 14. For example, the AMF 1306 may remove the capability set from the AMF 1306 in response to a timer associated with the capability set expiring. The removal of the capability set may be performed by, e.g., the stored capability removal component 2046 of the apparatus 2002 in FIG. 20.

In another example, the communication entity may receive, from the UE, a notification to deactivate the plurality of capability sets, such as described in connection with FIGS. 13 and 14. For example, at 1326, the AMF 1306 may receive, from the UE 1302, a notification to deactivate the plurality of capability sets. The reception of the notification to deactivate the plurality of capability sets may be performed by, e.g., the capability deactivation process component 2048 and/or the reception component 2030 of the apparatus 2002 in FIG. 20.

FIG. 20 is a diagram 2000 illustrating an example of a hardware implementation for an apparatus 2002. The apparatus 2002 may be a communication entity, a component of a communication entity, or may implement communication functionality. In some aspects, the apparatus 2002 may include a baseband unit 2004. The baseband unit 2004 may communicate through at least one transceiver 2022 (e.g., one or more RF transceivers and/or antennas) with the UE 104, the base station 102/180, an LMF, the AMF 192, and/or a GMLC. The at least one transceiver 2022 may be associated with or include a reception component 2030 and/or a transmission component 2034. The baseband unit 2004 may include a computer-readable medium/memory (e.g., a memory 2026). The baseband unit 2004 and/or the at least one processor 2028 may be responsible for general processing, including the execution of software stored on the computer-readable medium/memory. The software, when executed by the baseband unit 2004 and/or the at least one processor 2028, causes the baseband unit 2004 and/or the at least one processor 2028 to perform the various functions described supra. The computer-readable medium/memory may also be used for storing data that is manipulated by the baseband unit 2004 when executing software. The baseband unit 2004 further includes the reception component 2030, a communication manager 2032, and the transmission component 2034. The reception component 2030 and the transmission component 2034 may, in a non-limiting example, include at least one transceiver and/or at least one antenna subsystem. The communication manager 2032 includes the one or more illustrated components. The components within the communication manager 2032 may be stored in the computer-readable medium/memory and/or configured as hardware within the baseband unit 2004. The baseband unit 2004 may be a component of the RF sensing node and may include the memory 376 and/or at least one of the TX processor 316, the RX processor 370, and the controller/processor 375.

The communication manager 2032 includes a capability storage component 2040 that receives, from a UE, a plurality of capability sets associated with UE positioning processing, the plurality of capability sets including at least a first capability set corresponding to a first level of the UE positioning processing and a second capability set corresponding to a second level of the UE positioning processing, the first level being different from the second level, e.g., as described in connection with 1802 of FIG. 18 and/or 1902 of FIG. 19. The communication manager 2032 further includes a capability activation process component 2042 that receives, from the UE, an indication to activate one of the plurality of capability sets for UE positioning, e.g., as described in connection with 1804 of FIG. 18 and/or 1904 of FIG. 19. The communication manager 2032 further includes a stored capability forward component 2044 that transmits, to an LMF, the one of the plurality of capability sets activated by the UE for a UE positioning session associated with the UE, e.g., as described in connection with 1806 of FIG. 18. The stored capability forward component 2044 may also transmit, to an LMF, the plurality of capability sets for a UE positioning session associated with the UE, e.g., as described in connection with 1808 of FIG. 18. The communication manager 2032 further includes a stored capability removal component 2046 that removes the capability set from the communication entity in response to the timer expiring, e.g., as described in connection with 1810 of FIG. 18. The communication manager 2032 further includes a capability deactivation process component 2048 that receives, from the UE, a notification to deactivate the plurality of capability sets, e.g., as described in connection with 1812 of FIG. 18.

The apparatus may include additional components that perform each of the blocks of the algorithm in the flowcharts of FIGS. 18 and 19. As such, each block in the flowcharts of FIGS. 18 and 19 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

As shown, the apparatus 2002 may include a variety of components configured for various functions. In one configuration, the apparatus 2002, and in particular the baseband unit 2004, includes means for receiving, from a UE, a plurality of capability sets associated with UE positioning processing, the plurality of capability sets including at least a first capability set corresponding to a first level of the UE positioning processing and a second capability set corresponding to a second level of the UE positioning processing, the first level being different from the second level (e.g., the capability storage component 2040 and/or the reception component 2030). The apparatus 2002 includes means for receiving, from the UE, an indication to activate one of the plurality of capability sets for UE positioning (e.g., the capability activation process component 2042 and/or the reception component 2030). The apparatus 2002 includes means for transmitting, to an LMF, the one of the plurality of capability sets activated by the UE for a UE positioning session associated with the UE (e.g., the stored capability forward component 2044 and/or the transmission component 2034). The apparatus 2002 includes means for transmitting, to an LMF, the plurality of capability sets for a UE positioning session associated with the UE (e.g., the stored capability forward component 2044 and/or the transmission component 2034). The apparatus 2002 includes means for removing the capability set from the communication entity in response to the timer expiring (e.g., the stored capability removal component 2046). The apparatus 2002 includes means for receiving, from the UE, a notification to deactivate the plurality of capability sets (e.g., the capability deactivation process component 2048 and/or the reception component 2030).

In one configuration, one or more of the plurality of capability sets may be received from the UE via a base station, or the indication may be received from the UE via a base station.

In another configuration, the communication entity may be an AMF, a sidelink UE, a base station, or an LMF. In such a configuration, the indication may be received via a lower layer signaling, UCI, an UL MAC-CE if the communication entity is the AMF. In such a configuration, the indication may be received via a higher layer signaling, SCI, or SL MAC-CE if the communication entity is the sidelink UE, the base station, or the LMF.

In another configuration, the indication may be received periodically.

In another configuration, the plurality of capability sets may be received at a same time.

In another configuration, the first capability set and the second capability set may be received at a different time. In such a configuration, the apparatus 2002 includes means for receiving, from the UE, a third capability set corresponding to a third level of the UE positioning processing, where the third level is different from the first level and the second level.

In another configuration, no more than one capability set of the plurality of capability sets may be activated at a time.

In another configuration, the indication may be received prior to a UE positioning session.

In another configuration, the plurality of capability sets may be stored at the communication entity, each of the plurality of capability sets being associated with a timer that indicates a time in which a capability set is to be stored.

The means may be one or more of the components of the apparatus 2002 configured to perform the functions recited by the means. As described supra, the apparatus 2002 may include the TX Processor 316, the RX Processor 370, and the controller/processor 375. As such, in one configuration, the means may be the TX Processor 316, the RX Processor 370, and the controller/processor 375 configured to perform the functions recited by the means.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Terms such as “if,” “when,” and “while” should be interpreted to mean “under the condition that” rather than imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

The following aspects are illustrative only and may be combined with other aspects or teachings described herein, without limitation.

Aspect 1 is an apparatus for wireless communication including a memory; at least one transceiver; and at least one processor communicatively connected to the memory and the at least one transceiver, the at least one processor configured to: transmit, to at least one of a second UE, a base station, or a network entity, a plurality of capability sets associated with UE positioning processing, the plurality of capability sets including at least a first capability set corresponding to a first level of the UE positioning processing and a second capability set corresponding to a second level of the UE positioning processing, the first level being different from the second level; and transmit, to the at least one of the second UE, the base station, or the network entity, an indication to activate one of the plurality of capability sets for UE positioning.

Aspect 2 is the apparatus of aspect 1, where the plurality of capability sets is transmitted to the network entity, the network entity being an AMF.

Aspect 3 is the apparatus of any of aspects 1 and 2, where one or more of the plurality of capability sets are transmitted to the AMF via the base station, or where the indication is transmitted to the AMF via the base station.

Aspect 4 is the apparatus of any of aspects 1 to 3, where the indication is transmitted via a lower layer signaling, UCI, or an UL MAC-CE.

Aspect 5 is the apparatus of any of aspects 1 to 4, where the plurality of capability sets is transmitted to the at least one of the second UE, the base station, or the network entity, the network entity being an LMF and the plurality of capability sets being associated with SL UE positioning processing.

Aspect 6 is the apparatus of any of aspects 1 to 5, where the indication is transmitted via a higher layer signaling, SCI, or SL MAC-CE.

Aspect 7 is the apparatus of any of aspects 1 to 6, where the plurality of capability sets is broadcasted or groupcasted to a plurality of sidelink devices including the second UE.

Aspect 8 is the apparatus of any of aspects 1 to 7, where the indication is transmitted periodically or updated periodically.

Aspect 9 is the apparatus of any of aspects 1 to 8, where the plurality of capability sets is transmitted at a same time.

Aspect 10 is the apparatus of any of aspects 1 to 9, where the first capability set and the second capability set are transmitted at a different time.

Aspect 11 is the apparatus of any of aspects 1 to 10, where the at least one processor is further configured to: transmit, to the at least one of the second UE, the base station, or the network entity, a third capability set corresponding to a third level of the UE positioning processing, where the third level is different from the first level and the second level.

Aspect 12 is the apparatus of any of aspects 1 to 11, where the plurality of capability sets is stored at the at least one of the second UE, the base station, or the network entity, each of the plurality of capability sets being associated with a timer that indicates a time in which a capability set is to be stored, such that the capability set is removed from the at least one of the second UE, the base station, or the network entity in response to the timer expiring.

Aspect 13 is the apparatus of any of aspects 1 to 12, where no more than one capability set of the plurality of capability sets is to be activated at a time.

Aspect 14 is the apparatus of any of aspects 1 to 13, where the at least one processor is further configured to: transmit, to the at least one of the second UE, the base station, or the network entity, a notification to deactivate the plurality of capability sets.

Aspect 15 is the apparatus of any of aspects 1 to 14, where the indication is transmitted prior to a UE positioning session.

Aspect 16 is a method of wireless communication for implementing any of aspects 1 to 15.

Aspect 17 is an apparatus for wireless communication including means for implementing any of aspects 1 to 15.

Aspect 18 is a computer-readable medium storing computer executable code, where the code when executed by a processor causes the processor to implement any of aspects 1 to 15.

Aspect 19 is an apparatus for wireless communication including a memory; at least one transceiver; and at least one processor communicatively connected to the memory and the at least one transceiver, the at least one processor configured to: receive, from a UE, a plurality of capability sets associated with UE positioning processing, the plurality of capability sets including at least a first capability set corresponding to a first level of the UE positioning processing and a second capability set corresponding to a second level of the UE positioning processing, the first level being different from the second level; and receive, from the UE, an indication to activate one of the plurality of capability sets for UE positioning.

Aspect 20 is the apparatus of aspect 19, where one or more of the plurality of capability sets are received from the UE via a base station, or where the indication is received from the UE via a base station.

Aspect 21 is the apparatus of any of aspects 19 and 20, where the communication entity is an AMF, a sidelink UE, a base station, or an LMF.

Aspect 22 is the apparatus of any of aspects 19 to 21, where the indication is received via a lower layer signaling, UCI, an UL MAC-CE if the communication entity is the AMF.

Aspect 23 is the apparatus of any of aspects 19 to 22, where the indication is received via a higher layer signaling, SCI, or SL MAC-CE if the communication entity is the sidelink UE, the base station, or the LMF.

Aspect 24 is the apparatus of any of aspects 19 to 23, where the at least one processor is further configured to: transmit, to an LMF, the one of the plurality of capability sets activated by the UE for a UE positioning session associated with the UE.

Aspect 25 is the apparatus of any of aspects 19 to 24, where the at least one processor is further configured to: transmit, to an LMF, the plurality of capability sets for a UE positioning session associated with the UE.

Aspect 26 is the apparatus of any of aspects 19 to 25, where the indication is received periodically.

Aspect 27 is the apparatus of any of aspects 19 to 26, where the plurality of capability sets is received at a same time.

Aspect 28 is the apparatus of any of aspects 19 to 27, where the first capability set and the second capability set are received at a different time.

Aspect 29 is the apparatus of any of aspects 19 to 28, where the at least one processor is further configured to: receive, from the UE, a third capability set corresponding to a third level of the UE positioning processing, where the third level is different from the first level and the second level.

Aspect 30 is the apparatus of any of aspects 19 to 29, where the plurality of capability sets is stored at the communication entity, each of the plurality of capability sets being associated with a timer that indicates a time in which a capability set is to be stored.

Aspect 31 is the apparatus of any of aspects 19 to 30, where the at least one processor is further configured to: remove the capability set from the communication entity in response to the timer expiring.

Aspect 32 is the apparatus of any of aspects 19 to 31, where no more than one capability set of the plurality of capability sets is to be activated at a time.

Aspect 33 is the apparatus of any of aspects 19 to 32, where the at least one processor is further configured to: receive, from the UE, a notification to deactivate the plurality of capability sets.

Aspect 34 is the apparatus of any of aspects 19 to 33, where the indication is received prior to a UE positioning session.

Aspect 35 is a method of wireless communication for implementing any of aspects 19 to 34.

Aspect 36 is an apparatus for wireless communication including means for implementing any of aspects 19 to 34.

Aspect 37 is a computer-readable medium storing computer executable code, where the code when executed by a processor causes the processor to implement any of aspects 19 to 34.

What is claimed is:

1. An apparatus for wireless communication at a first user equipment (UE), comprising:
a memory;
at least one transceiver; and
at least one processor communicatively connected to the memory and the at least one transceiver, the at least one processor configured to:
transmit, to at least one of a second UE, a base station, or a network entity, a plurality of capability sets associated with UE positioning processing, the plurality of capability sets including at least a first capability set corresponding to a first level of the UE positioning processing and a second capability set corresponding to a second level of the UE positioning processing, the first level being different from the second level; and
transmit, to the at least one of the second UE, the base station, or the network entity, an indication to activate one of the plurality of capability sets for UE positioning.

2. The apparatus of claim 1, wherein the plurality of capability sets is transmitted to the network entity, the network entity being an access and mobility management function (AMF).

3. The apparatus of claim 2, wherein one or more of the plurality of capability sets are transmitted to the AMF via the base station, or wherein the indication is transmitted to the AMF via the base station.

4. The apparatus of claim 2, wherein the indication is transmitted via a lower layer signaling, uplink control information (UCI), or an uplink (UL) medium access control (MAC)-control element (UL MAC-CE).

5. The apparatus of claim 1, wherein the plurality of capability sets is transmitted to the at least one of the second UE, the base station, or the network entity, the network entity being a location management function (LMF) and the plurality of capability sets being associated with sidelink (SL) UE positioning processing, and wherein the indication is transmitted via a higher layer signaling, sidelink control information (SCI), or a SL medium access control (MAC)-control element (SL MAC-CE).

6. The apparatus of claim 5, wherein the plurality of capability sets is broadcasted or groupcasted to a plurality of sidelink devices including the second UE.

7. The apparatus of claim 1, wherein the indication is transmitted periodically or updated periodically.

8. The apparatus of claim 1, wherein the plurality of capability sets is transmitted at a same time.

9. The apparatus of claim 1, wherein the first capability set and the second capability set are transmitted at a different time.

10. The apparatus of claim 9, wherein the at least one processor is further configured to:
transmit, to the at least one of the second UE, the base station, or the network entity, a third capability set corresponding to a third level of the UE positioning processing, wherein the third level is different from the first level and the second level.

11. The apparatus of claim 1, wherein the plurality of capability sets is stored at the at least one of the second UE, the base station, or the network entity, each of the plurality of capability sets being associated with a timer that indicates a time in which a capability set is to be stored, such that the capability set is removed from the at least one of the second UE, the base station, or the network entity in response to the timer expiring.

12. The apparatus of claim 1, wherein no more than one capability set of the plurality of capability sets is to be activated at a time.

13. The apparatus of claim 1, wherein the at least one processor is further configured to:
transmit, to the at least one of the second UE, the base station, or the network entity, a notification to deactivate the plurality of capability sets.

14. The apparatus of claim 1, wherein the indication is transmitted prior to a UE positioning session.

15. A method of wireless communication at a first user equipment (UE), comprising:
transmitting, to at least one of a second UE, a base station, or a network entity, a plurality of capability sets associated with UE positioning processing, the plurality of capability sets including at least a first capability set corresponding to a first level of the UE positioning processing and a second capability set corresponding to a second level of the UE positioning processing, the first level being different from the second level; and
transmitting, to the at least one of the second UE, the base station, or the network entity, an indication to activate one of the plurality of capability sets for UE positioning.

16. An apparatus for wireless communication at a communication entity, comprising:
a memory;
at least one transceiver; and
at least one processor communicatively connected to the memory and the at least one transceiver, the at least one processor configured to:
receive, from a user equipment (UE), a plurality of capability sets associated with UE positioning processing, the plurality of capability sets including at least a first capability set corresponding to a first level of the UE positioning processing and a second capability set corresponding to a second level of the UE positioning processing, the first level being different from the second level; and
receive, from the UE, an indication to activate one of the plurality of capability sets for UE positioning.

17. The apparatus of claim 16, wherein one or more of the plurality of capability sets are received from the UE via a base station, or wherein the indication is received from the UE via the base station.

18. The apparatus of claim 16, wherein the communication entity is an access and mobility management function (AMF), a sidelink UE, a base station, or a location management function (LMF).

19. The apparatus of claim 18 wherein the indication is received via a lower layer signaling, uplink control information (UCI), an uplink (UL) medium access control (MAC)-control element (UL MAC-CE) if the communication entity is the AMF, or received via a higher layer signaling, sidelink control information (SCI), or a SL medium access control (MAC)-control element (SL MAC-CE) if the communication entity is the sidelink UE, the base station, or the LMF.

20. The apparatus of claim 16, wherein the at least one processor is further configured to:
transmit, to a location management function (LMF), the plurality of capability sets or one of the plurality of capability sets activated by the UE for a UE positioning session associated with the UE.

21. The apparatus of claim 16, wherein the indication is received periodically.

22. The apparatus of claim 16, wherein the plurality of capability sets is received at a same time.

23. The apparatus of claim 16, wherein the first capability set and the second capability set are received at a different time.

24. The apparatus of claim 23, wherein the at least one processor is further configured to:
receive, from the UE, a third capability set corresponding to a third level of the UE positioning processing, wherein the third level is different from the first level and the second level.

25. The apparatus of claim 16, wherein the plurality of capability sets is stored at the communication entity, each of the plurality of capability sets being associated with a timer that indicates a time in which a capability set is to be stored.

26. The apparatus of claim 25, wherein the at least one processor is further configured to:
remove the capability set from the communication entity in response to the timer expiring.

27. The apparatus of claim 16, wherein no more than one capability set of the plurality of capability sets is to be activated at a time.

28. The apparatus of claim 16, wherein the at least one processor is further configured to:
receive, from the UE, a notification to deactivate the plurality of capability sets.

29. The apparatus of claim 16, wherein the indication is received prior to a UE positioning session.

30. A method of wireless communication at a communication entity, comprising:
receiving, from a user equipment (UE), a plurality of capability sets associated with UE positioning processing, the plurality of capability sets including at least a first capability set corresponding to a first level of the UE positioning processing and a second capability set corresponding to a second level of the UE positioning processing, the first level being different from the second level; and
receiving, from the UE, an indication to activate one of the plurality of capability sets for UE positioning.
